(19) United States
(12) Patent Application Publication
(10) Pub. No.: US 2013/0041602 A1
(43) Pub. Date: Feb. 14, 2013

(54) RECORDING MATERIAL DETERMINATION DEVICE FOR DETERMINING WHETHER RECORDING MATERIALS ARE DOUBLY FED

(71) Applicants: Tsutomu Ishida, Suntou-gun (JP); Norio Matsui, Mishima-shi (JP); Shoichi Koyama, Susono-shi (JP); Shun-ichi Ebihara, Suntou-gun (JP)

(72) Inventors: Tsutomu Ishida, Suntou-gun (JP); Norio Matsui, Mishima-shi (JP); Shoichi Koyama, Susono-shi (JP); Shun-ichi Ebihara, Suntou-gun (JP)

(73) Assignee: CANON KABUSHIKI KAISHA, Tokyo (JP)

(21) Appl. No.: 13/559,136

(22) Filed: Jul. 26, 2012

(30) Foreign Application Priority Data
Aug. 12, 2011 (JP) 2011-177141

(51) Int. Cl. G01N 29/44

(52) U.S. Cl. 702/56

(57) ABSTRACT

A recording material determination device obtains a difference between a peak time, which is a first measurement result when an ultrasonic wave has passed through a recording material, and a peak time, which is a second or subsequent measurement result. The recording material determination device compares the difference with a double feed determination threshold value set based on the difference between the peak times, to precisely determine double feed of the recording materials without being influenced by an environment and the kind of the recording material.

### BACKGROUND OF THE INVENTION

1. Field of the Invention

The present invention relates to a recording material determination device configured to determine whether recording materials are doubly fed, and an image forming apparatus having the recording material determination device.

2. Description of the Related Art

A conventional image forming apparatus includes a feed conveyance mechanism configured to convey recording materials separately one by one to an image forming unit. However, in some cases, a plurality of recording materials have been conveyed with a part or the whole of the recording materials being overlapped without being separated by the feed conveyance mechanism (hereinafter, also referred to as double feed). When the recording materials are doubly fed and conveyed, jam may be generated. Therefore, an apparatus configured to detect double feed of recording materials is provided.

A double feed detection apparatus using an ultrasonic wave is discussed as one of methods for detecting double feed of recording materials. Main examples of an ultrasonic wave double feed detection method includes two methods such as an amplitude detection method configured to detect double feed based on attenuation in amplitude of the ultrasonic wave, and a phase detection method configured to detect double feed based on phase shift of the ultrasonic wave.

Japanese Patent Application Laid-Open No. 2003-160257 discusses an amplitude detection method in which a double feed determining threshold value is previously set for amplitudes to be obtained, emitting an ultrasonic wave to a recording material, and detecting amplitude of the ultrasonic wave having passed through the recording material. At this time, the amplitude of the ultrasonic wave obtained when the recording materials are doubly fed and conveyed, is greatly attenuated as compared with that obtained when the recording materials are normally conveyed one by one. Thus, the double feed of the recording materials can be detected by comparing the obtained amplitude of the ultrasonic wave with the double feed determining threshold value.

Japanese Patent Application Laid-Open No. 2003-176063 discusses a phase type detection method configured to emit an ultrasonic wave to a recording material, and detect phase information of the ultrasonic wave having passed through the recording material. The method compares phase information in a state where the recording material is not present between an ultrasonic generator and an ultrasonic receiver with a phase of the detected ultrasonic wave. The method counts the number of times when a phase difference exceeds a threshold value for determining double feed. The method determines that the recording materials are doubly laminated when the generated number of times is not less than a predetermined number of times.

The double feed determination methods discussed in Japanese Patent Application Laid-Open Nos. 2003-160257 and 2003-176063 perform a correction operation for performing calibration in a state where the recording material is not present, to detect a change in an output value according to variations in an ambient environment and arrangement of a sensor, and reflects the detected result to the threshold value. This is performed to precisely determine the double feed. However, the correction operation for setting the threshold value to determine the double feed and calculating a correction coefficient of the ambient environment may lead to a reduction in productivity.

### SUMMARY OF THE INVENTION

The present invention is directed to a recording material determination device capable of precisely determining double feed of recording materials without correcting a threshold value according to variations in an ambient environment and arrangement of a sensor.

According to an aspect of the present invention, a recording material determination device includes an emitting unit configured to emit an ultrasonic wave; a transmission unit configured to transmit a drive signal for emitting the ultrasonic wave from the emitting unit; a receiving unit configured to receive the ultrasonic wave emitted from the emitting unit and having passed through a recording material; and a control unit configured to measure a time until a peak of a received signal of the ultrasonic wave received by the receiving unit is detected after the drive signal is transmitted by the transmission unit, wherein the control unit causes the emitting unit to emit the ultrasonic wave more than once, measures the time more than once, and determines whether the recording materials are doubly fed based on a difference between the times measured more than once.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a schematic configuration of an image forming apparatus.

FIG. 2 is a block diagram illustrating a control system of a recording material determination device.

FIGS. 3A, 3B, and 3C, respectively, illustrate a waveform of a received signal of an ultrasonic wave having passed through a recording material P.

FIG. 4 is a flowchart illustrating a method for detecting double feed of recording materials P based on a difference between peak times of an ultrasonic wave.

FIGS. 5A and 5B are graphs in which peak times measured when recording materials P are doubly fed and when the recording materials P are not doubly fed are plotted.

FIGS. 6A and 6B are graphs in which peak times measured when recording materials P are doubly fed and when the recording materials P are not doubly fed at wave numbers different from those of FIGS. 5A and 5B are plotted.

FIG. 7 is a flowchart illustrating a method for detecting double feed of recording materials P based on a change in a peak value of an ultrasonic wave.

FIGS. 8A and 8B are graphs in which peak values measured when recording materials P are doubly fed and when the recording materials P are not doubly fed are plotted.

FIGS. 9A and 9B are graphs in which peak values measured when recording materials P are doubly fed and when the recording materials P are not doubly fed at wave numbers different from those of FIGS. 8A and 8B are plotted.

FIGS. 10A, 10B, and 10C, respectively, illustrate a waveform of a received signal of an ultrasonic wave having passed through a recording material P.

FIG. 11 is a flowchart illustrating a method for detecting double feed of recording materials P based on a change amount of a time of a peak of an ultrasonic wave.

FIG. 12 is a flowchart illustrating a method for detecting double feed of recording materials P based on a change amount of a peak value of an ultrasonic wave.

FIG. 13 (13A+13B) is a flowchart illustrating a method for detecting a double feed state and a basis weight of recording materials P.

FIG. 14 is a graph illustrating a relationship between a basis weight and a transmission coefficient of a recording material P.

FIG. 15 is a flowchart illustrating a method for detecting and adjusting a double feed state and a basis weight of recording materials P.

### DESCRIPTION OF THE EMBODIMENTS

The accompanying drawings, which are incorporated in and constitute a part of the specification, illustrate exemplary embodiments, features, and aspects of the invention and, together with the description, serve to explain the principles of the invention.

The following exemplary embodiments do not restrict the invention recited in the scope of claims. All the combinations of the features described in the exemplary embodiments are not always essential to means for solving problems of the present invention.

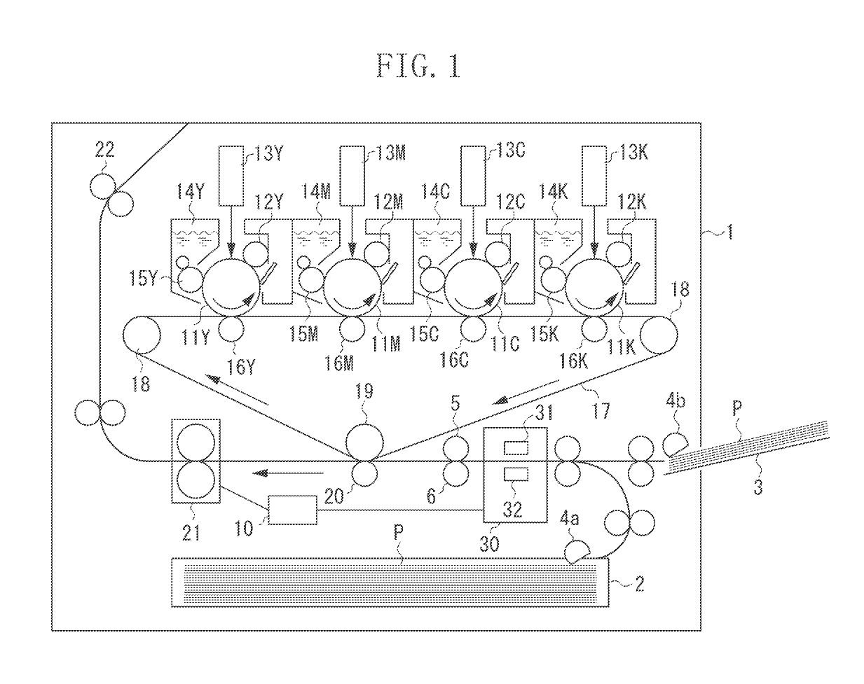

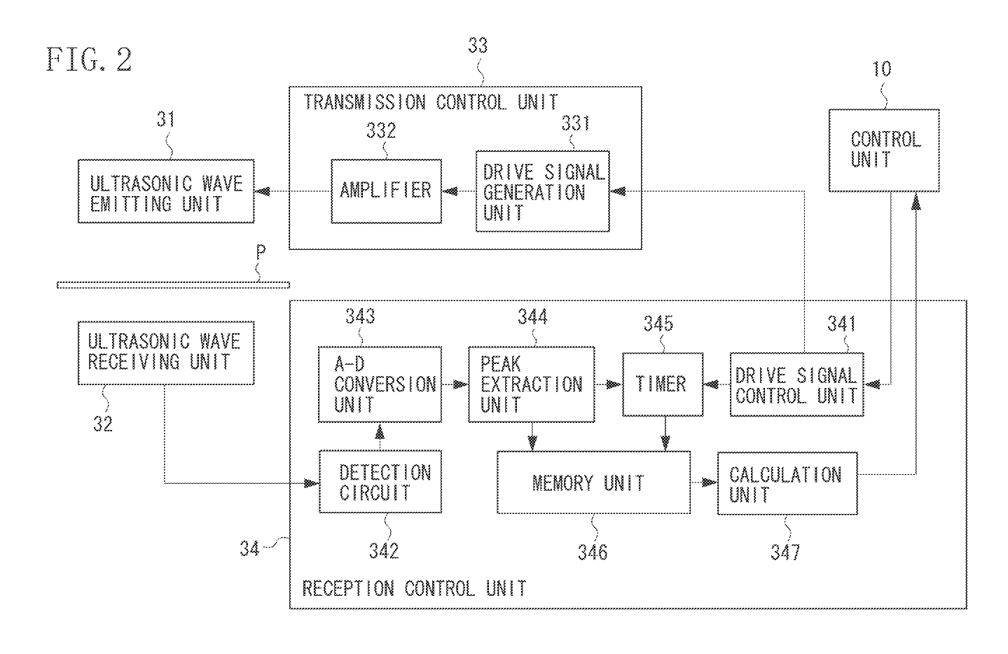

A recording material determination device according to an exemplary embodiment of the present invention can be used in an image forming apparatus, e.g., a copying machine and a printer. FIG. 1 illustrates a schematic configuration of the image forming apparatus having a recording material determination device as an example, and including an intermediate transfer belt and a plurality of image forming units arranged in parallel.

A configuration of an image forming apparatus 1 in FIG. 1 is described below. A paper feed cassette 2 stores recording materials P. A paper feed tray 3 is for stacking the recording materials P. A paper feed roller 4a feeds the recording materials P from the paper feed cassette 2. A paper feed roller 4b feeds the recording materials P from the paper feed tray 3. A conveyance roller 5 conveys fed recording materials P. A conveyance counter roller 6 is positioned opposing to the conveyance roller 5. Photosensitive drums 11Y, 11M, 11C, and 11K, respectively, bear developers of colors of yellow, magenta, cyan, and black. Charging rollers 12Y, 12M, 12C, and 12K, as primary charging units for the respective colors, respectively, uniformly charge the photosensitive drums 11Y, 11M, 11C, and 11K to a predetermined potential. Optical units 13Y, 13M, 13C, and 13K, respectively, expose the photosensitive drums 11Y, 11M, 11C, and 11K charged by the primary charging units to laser light corresponding to image data of the respective colors to form electrostatic latent images thereon.

Development units 14Y, 14M, 14C, and 14K, respectively, visualize the electrostatic latent images formed on the photosensitive drums 11Y, 11M, 11C, and 11K. Developing rollers 15Y, 15M, 15C, and 15K, respectively, send developers within the development units 14Y, 14M, 140, and 14K to portions opposing to the photosensitive drums 11Y, 11M, 11C, and 11K.

Primary transfer rollers 16Y, 16M, 16C, and 16K for the respective colors primary-transfer images formed on the photosensitive drums 11Y, 11M, 11C, and 11K. An intermediate transfer belt 17 carries the primary transferred image. Drive rollers 18 drive the intermediate transfer belt 17.

A secondary transfer roller 19 transfers the image formed on the intermediate transfer belt 17 onto the recording material P. A secondary transfer counter roller 20 is arranged opposing to the secondary transfer roller 19. A fixing unit 21 fuses and fixes a developer image transferred onto the recording material P onto the recording material P while conveying the recording material P. Discharge rollers 22 discharge the recording material P after the fixing processing is performed by the fixing unit 21.

The photosensitive drums 11Y, 11M, 11C, and 11K, the charging rollers 12Y, 12M, 12C, and 12K, the development units 14Y, 14M, 14C, and 14K, and the developing rollers 15Y, 15M, 15C, and 15K, respectively, are combined for each of the respective colors. A combination of the photosensitive drum, the charging roller, and the development unit is referred to as a cartridge. The cartridges of the respective colors are configured so that each cartridge can be removed from a body of the image forming apparatus with ease.

Now, an image forming operation performed by the image forming apparatus 1 is described below. Print data containing a print order and image information is input into the image forming apparatus 1 from, for example, a host computer (not illustrated). Then, the image forming apparatus 1 starts a printing operation and thus the recording material P is fed from the paper feed cassette 2 or the paper feed stray 3 by the paper feed roller 4a or the paper feed roller 4b to be sent out into the conveyance path.

The recording material P once stops at the conveyance roller 5 and the conveyance counter roller 6 to wait for the image formation to synchronize timing of the image forming operation of the image to be formed on the intermediate transfer belt 17 with timing of a conveyance of the recording material P. The recording material P is fed concurrently with the image forming operation wherein the photosensitive drums 11Y, 11M, 11C, and 11K are charged to a predetermined potential by the charging rollers 12Y, 12M, 12C, and 12K.

According to the input print data, the optical units 13Y, 13M, 13C, and 13K expose charged surfaces of the photosensitive drums 11Y, 11M, 11C, and 11K to a laser beam, scan the surfaces thereof, and form electrostatic latent images.

In order to visualize the formed electrostatic latent images, development of the electrostatic latent images are performed by the development units 14Y, 14M, 14C, and 14K and the developing rollers 15Y, 15M, 15C, and 15K. The electrostatic latent images formed on the surfaces of the photosensitive drums 11Y, 11M, 11C, and 11K are developed into images of the respective colors by the development units 14Y, 14M, 14C, and 14K.

The photosensitive drums 11Y, 11M, 11C, and 11K contact the intermediate transfer belt 17 to rotate in synchronization with a rotation of the intermediate transfer belt 17. Each of the developed images is sequentially transferred onto the intermediate transfer belt 17 in a multi layered manner by the primary transfer rollers 16Y, 16M, 16C, and 16K. Then, each of the developed images is secondary transferred onto the recording material P by the secondary transfer roller 19 and the secondary transfer counter roller 20.

Subsequently, to secondary-transfer each of the developed images onto the recording material P in synchronization with the image forming operation, the recording material P is conveyed to the secondary transfer unit. The image formed on the intermediate transfer belt 17 is transferred onto the recording material P by the secondary transfer roller 19 and the secondary transfer counter roller 20.

The developer image transferred onto the recording material P is fixed thereon by the fixing unit 21 including fixing rollers. The recording material P after the fixing operation is discharged to a discharge tray (not illustrated) by the discharge rollers 22. Then, the image forming operation is ended.

In the image forming apparatus illustrated in FIG. 1, a recording material determination device 30 according to the present exemplary embodiment is disposed on the upstream side of the conveyance roller 5 and the conveyance counter roller 6. The recording material determination device 30 can detect information reflecting double feed of the recording materials P conveyed from the paper feed cassette 2.

In the present exemplary embodiment, the recording material determination device 30 performs determination when the recording material P is conveyed before the recording material P is sent out into the image forming apparatus from the paper feed cassette 2, and is sandwiched between the conveyance roller 5 and the conveyance counter roller 6. Alternatively, the recording material determination device 30 performs determination when the recording material P is conveyed with the recording material P sandwiched between the conveyance roller 5 and the conveyance counter roller 6.

Subsequently, the recording material determination device 30 according to the present exemplary embodiment will be described with reference to FIG. 2 which is a block diagram illustrating a control system configured to control the operation thereof.

An ultrasonic wave emitting unit 31 emits an ultrasonic wave to the recording material P. An ultrasonic wave receiving unit 32 receives the ultrasonic wave having passed through the recording material P. In the present exemplary embodiment, the ultrasonic wave emitting unit 31 emits an ultrasonic wave having a frequency characteristic of 40 kHz, and the ultrasonic wave receiving unit 32 receives the ultrasonic wave. The frequency of the ultrasonic wave is previously determined. A frequency of an appropriate range may be selected according to the configurations of the ultrasonic wave emitting unit 31 and the ultrasonic wave receiving unit 32 and detection accuracy. The frequency is not restricted thereto.

A transmission control unit 33 has a function of generating a drive signal for emitting an ultrasonic wave and of amplifying the drive signal. A reception control unit 34 has a function of detecting the ultrasonic wave received by the ultrasonic wave receiving unit 32 as a voltage and of processing a signal. The recording material determination device 30 is composed by combining these units and a control unit 10.

The determined result by the control unit 10 can be used to control image forming conditions such as a motor drive, a fixing conveyance speed, and a fixing controlled temperature.

Next, a series of operations will be described. The control unit 10 inputs a signal indicating measurement start into a drive signal control unit 341. When the drive signal control unit 341 receives the input signal, the drive signal control unit 341 notifies generation of an ultrasonic wave emitting signal to a drive signal generation unit 331 to emit an ultrasonic wave having a predetermined frequency.

A pulse wave having a constant cycle as the driving signal is input so that the ultrasonic wave receiving unit 32 can receive only a direct wave emitted by the ultrasonic wave emitting unit 31 to reduce the influence of outer disturbance such as a reflective wave caused by the recording material P and members around the conveyance path. The pulse wave is called a burst wave.

In the present exemplary embodiment, five pulses of a pulse wave of 40 kHz are continuously input every 20 ms. Simultaneously, a timer 345 is reset, and a counter is started. The drive signal generation unit 331 generates and outputs a signal having a previously set frequency. An amplifier 332 amplifies the level (voltage value) of a signal, and outputs the signal to the ultrasonic wave emitting unit 31.

The ultrasonic wave receiving unit 32 receives the ultrasonic wave emitted from the ultrasonic wave emitting unit 31, or the ultrasonic wave having passed through the recording material P, and outputs the resultant signal to a detection circuit 342 of the reception control unit 34. The detection circuit 342 has a function of amplifying the signal and a function of rectifying the signal.

The amplifying function of the present exemplary embodiment can vary an amplification factor in a state where the recording material P is not present between the ultrasonic wave emitting unit 31 and the ultrasonic wave receiving unit 32 and in a state where the recording material P is present between the ultrasonic wave emitting unit 31 and the ultrasonic wave receiving unit 32. However, the amplifying function is not restricted thereto. For example, the amplification factor in the non-present state may be the same as that in the present state. Half-wave rectification is performed as the rectifying function. However, the rectifying function is not restricted thereto, and for example, both wave rectification may be performed.

An A-D conversion unit 343 converts the signal generated in the detection circuit 342 into a digital signal from an analog signal. In the present exemplary embodiment, the signal is converted into a 12-bit digital signal corresponding to the output of the detection circuit 342. However, the digital signal is not restricted thereto. The analog signal may be appropriately converted into a digital signal of a plurality of bits.

A peak extraction unit 344 extracts a peak (local maximum value) of the signal based on the converted digital signal. The timer 345 resets a timer from starting of an ultrasonic wave drive signal, and starts counting. The peak extraction unit 344 performs processing in time series, and extracts a value of the timer 345 at the timing when the peak is detected.

At the timing of one measurement end, a memory unit 346 stores the value extracted by the peak extraction unit 344, and the value extracted by the timer 345 as one set. A calculation unit 347 performs a plurality of measurements, and calculates a difference between values obtained by the measurements. The control unit 10 determines the double feed of the recording materials P based on the values calculated by the calculation unit 347, and controls the operation of the image forming apparatus according to the result.

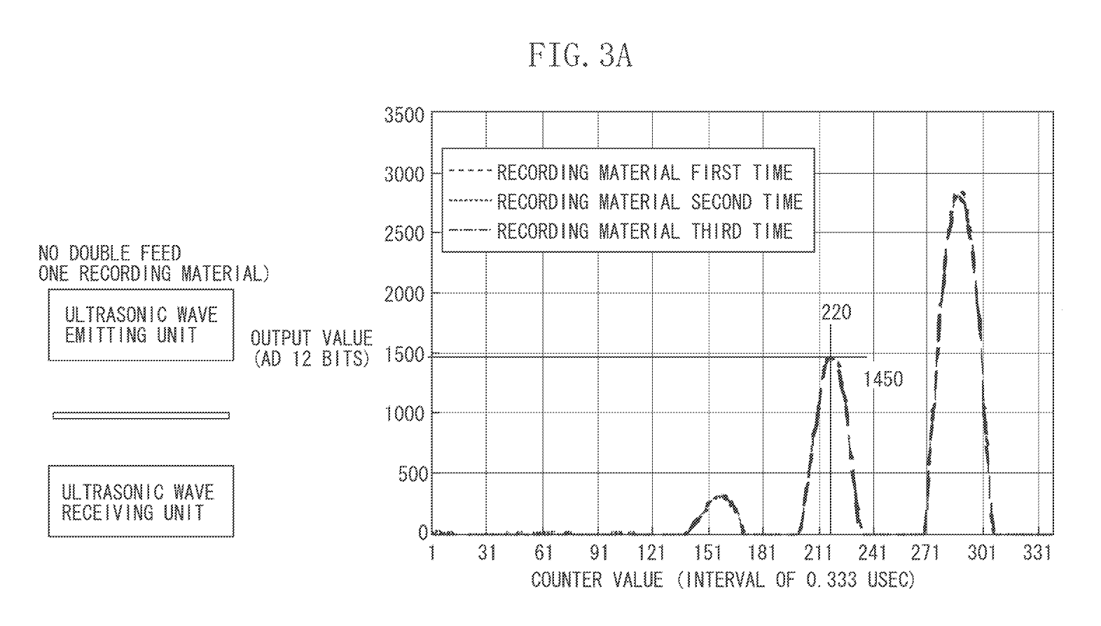

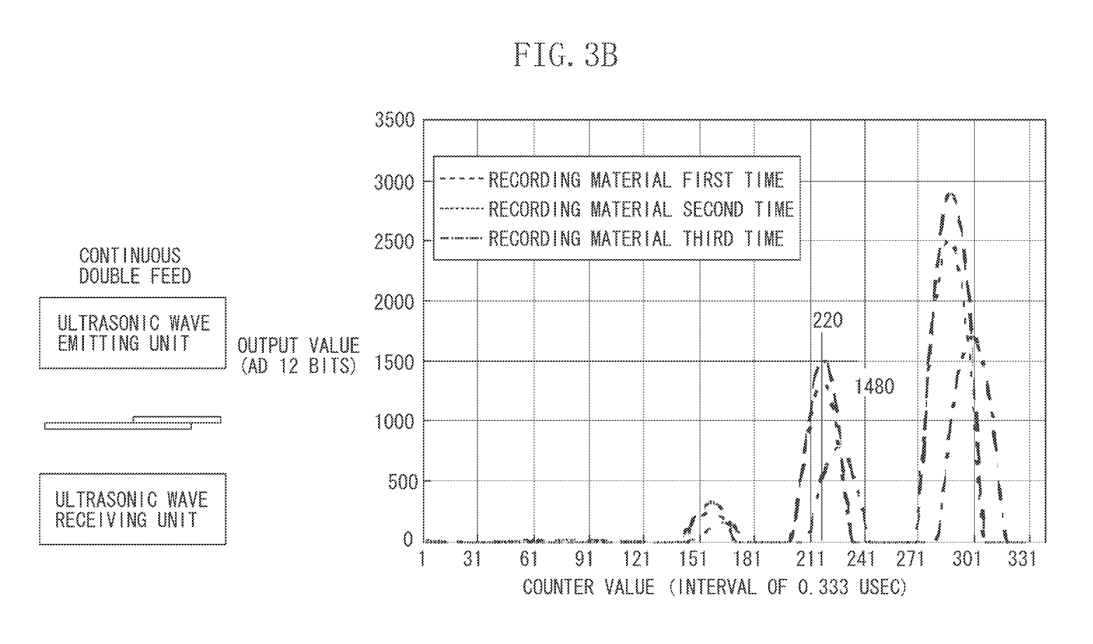

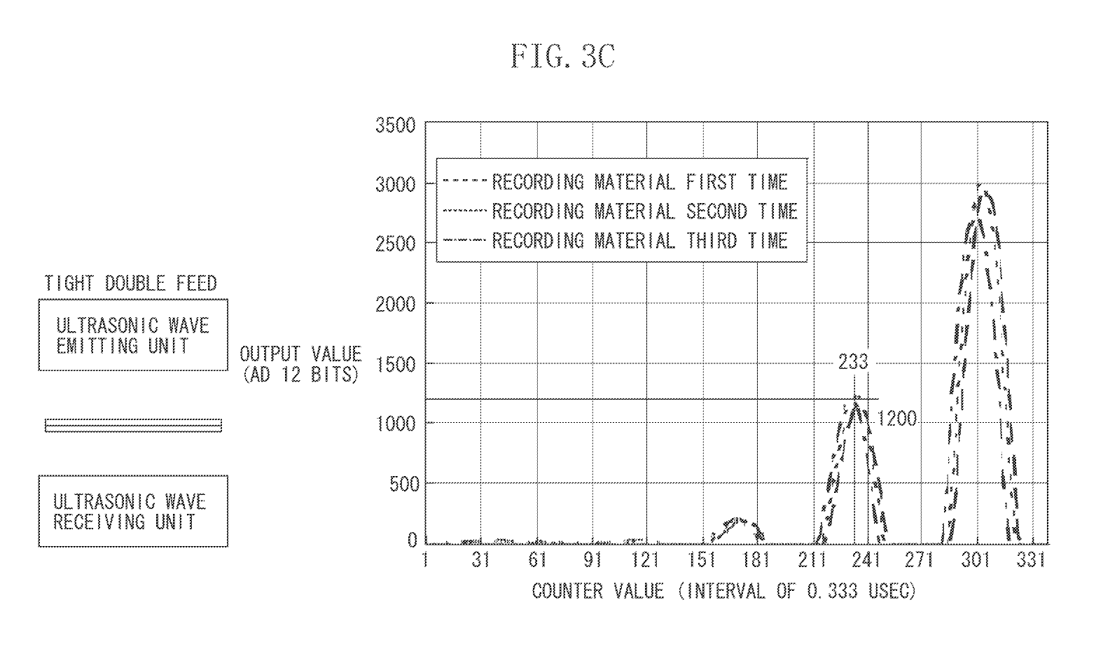

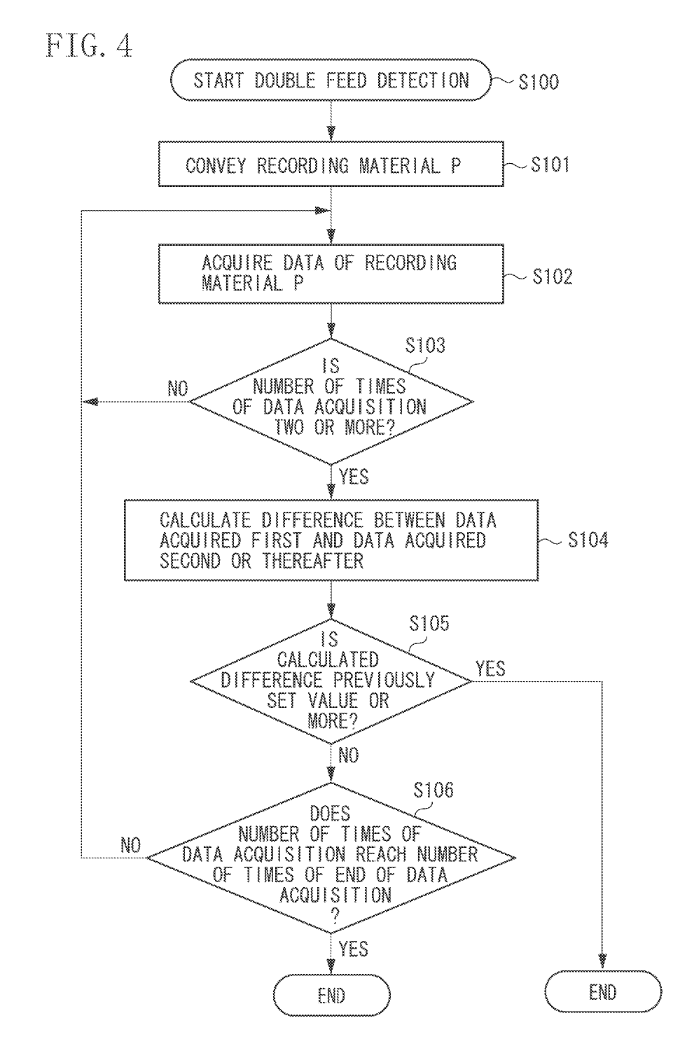

FIG. 3 illustrates a waveform of a received signal of the ultrasonic wave having passed through the recording material P according to the present exemplary embodiment. The used recording material has a basis weight of 60 g/m². FIG. 3A illustrates data when one recording material P is conveyed.

FIG. 3B illustrates data when the recording materials P are doubly feed on the way of conveyance of the recording materials P (hereinafter, referred to as continuous double feed). FIG. 3C illustrates data when the recording materials P are conveyed with the recording materials P overlapped without shifting from each other (hereinafter, referred to as tight double feed). In each data, three measured waveforms are described with the waveforms being overlapped.

It can be seen that when one recording material P is conveyed, the difference between peak values measured more than once and the difference between peak times are very small. It can be seen that when the recording materials P are continuously and doubly fed, the peak values are attenuated as compared with the case where the recording materials P are not doubly fed, and times when the peaks appear are delayed.

It can also be seen that the three measurement results vary. It can be seen that when the recording materials P are tightly and doubly fed, the peak values are attenuated as compared with the case where the recording materials P are not doubly fed, and times when the peaks appear are delayed. It can be seen that three measurement results vary. Therefore, the double feed of the recording materials P can be determined based on the change amount of each of the measurement results of the recording materials P measured more than once.

Next, a method for detecting double feed of recording materials P based on a difference between peak times of an ultrasonic wave will be described with reference to a flowchart of FIG. 4.

In step S101, the control unit 10 conveys the recording material P between the ultrasonic wave emitting unit 31 and the ultrasonic wave receiving unit 32 of the recording material determination device 30. In step S102, the control unit 10 causes the ultrasonic wave emitting unit 31 to emit the ultrasonic wave to the recording material P. The ultrasonic wave receiving unit 32 receives the ultrasonic wave having passed through the recording material P. The control unit 10 measures peak times from the received ultrasonic wave. The control unit 10 stores the measured results in the memory unit 346.

In step S103, the control unit 10 determines whether the number of times of data acquisition of the recording material P is 2 or more. It is necessary to calculate a difference between the peak times to determine the double feed. Therefore, it is necessary to measure data more than once. When the number of times of data acquisition is 1 (NO in step S103), the processing returns to step S102, and the control unit 10 acquires data again.

When the number of times of data acquisition of the recording material P is 2 or more (YES in step S103), in step S104, the control unit 10 calculates a difference between data first acquired and data acquired second or thereafter.

In step S105, the control unit 10 compares the value calculated in step S104 with a previously set threshold value. As a result of the comparison, when the calculated value is smaller than the threshold value (NO in step S105), the control unit 10 determines that the recording materials P are not doubly fed, and the processing proceeds to step S106. When the calculated value is more than the threshold value (YES in step S105), the control unit 10 determines that the recording materials P are doubly fed, and ends the processing.

In step S106, the control unit 10 determines whether the number of times of data acquisition reaches the number of times of end of data acquisition. When the number of times of data acquisition does not reach the number of times of end of data acquisition (NO in step S106), the processing returns to step S102, and the control unit 10 acquires data again. When the number of times of data acquisition reaches the number of times of end of data acquisition (YES in step S106), the control unit 10 determines that the recording materials P are not doubly feed, and ends the processing.

In the present exemplary embodiment, as an example, the number of times of end of data acquisition is set to 20. This number of times is the number of times of the ultrasonic wave capable of being emitted more than once by the ultrasonic wave emitting unit 31 and of being received more than once by the ultrasonic wave receiving unit 32 while the recording material P is present between the ultrasonic wave emitting unit 31 and the ultrasonic wave receiving unit 32. The upper limit of the number of times of measurement can be appropriately set from a conveyance speed of the recording material P and a time when received data of the ultrasonic wave is acquired.

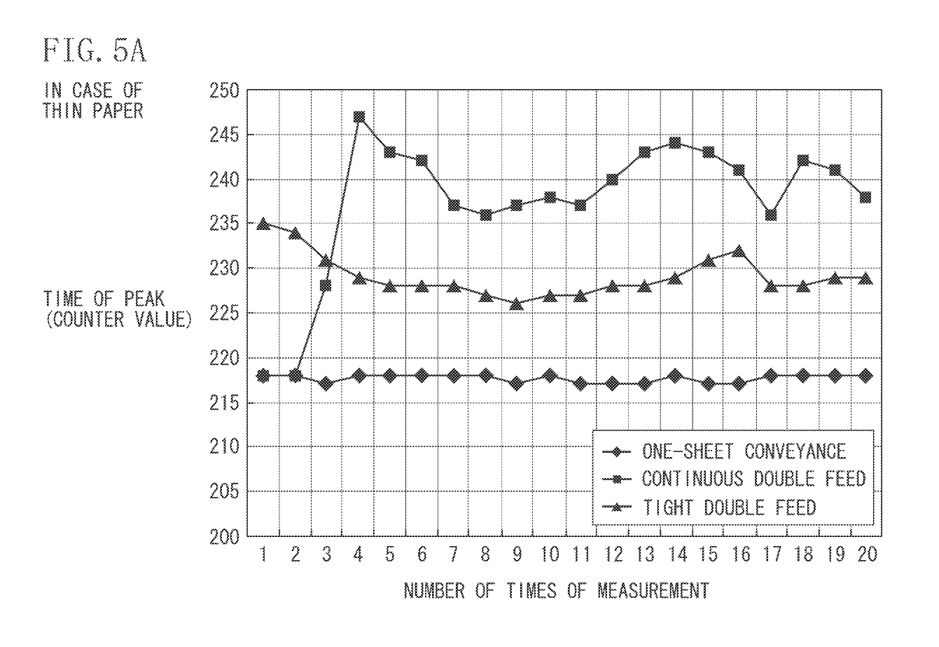

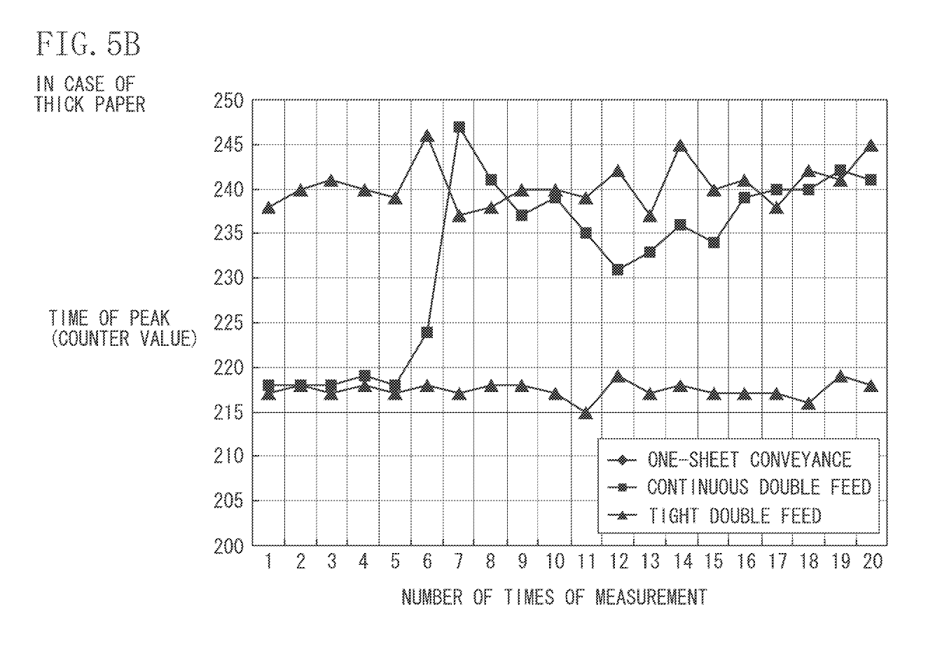

FIGS. 5A and 5B are graphs in which peak times measured when the recording materials P are doubly fed and when the recording materials P are not doubly fed are plotted. The recording material P used in FIG. 5A has a basis weight of 60 g/m². The recording material P used in FIG. 5B has a basis weight of 160 g/m². A counter value which is a double feed determination threshold value is set to 4 counts. The double feed determination threshold value is an example in the present exemplary embodiment, and can be appropriately set by the cycle of the counter or the sampling cycle of the A-D conversion unit.

In FIG. 5A, in the case of the one-sheet conveyance, the difference between the peak times calculated from the first measurement result and the second or succeeding measurement result is up to about 1 count.

Variations in time when the peaks are detected are reduced in a state where the recording materials P are not doubly fed. Therefore, since the difference does not exceed the threshold value, the control unit 10 can determine that the recording materials P are not doubly fed. In the case of the continuous double feed, it can be seen that the difference between the first measurement result and the third measurement result as the difference between the peak times calculated from the first measurement result and the second or subsequent measurement result is about 15 counts.

Since the recording materials P are continuously and doubly fed, variations in peak time of the first one-sheet conveyance are reduced. However, it can be seen that variations in peak time of doubly fed portions are greatly increased. Therefore, the control unit 10 can determine that the recording materials P are doubly fed because the difference exceeds the threshold value.

It can be seen that the difference between the first measurement result and the third measurement result as the difference between the peak times calculated from the first measurement result and the second or subsequent measurement result is about 4 counts in the case of the tight double feed. It can be seen that variations are wholly increased as compared with the peak times at the time of the one-sheet conveyance because the recording materials P are tightly and doubly fed. Therefore, the control unit 10 can determine that the recording materials P are doubly fed because the difference exceeds the threshold value.

In FIG. 5B, in the case of the one-sheet conveyance, the difference between the peak times calculated from the first measurement result and the second or subsequent measurement result is up to about 2 counts. Since variations in time when the peaks are detected are reduced in a state where the recording materials P are not doubly fed, the control unit 10 can determine that the recording materials P are not doubly fed.

It can be seen that the difference between the first measurement result and the sixth measurement result as the difference between the peak times calculated from the first measurement result and the second or subsequent measurement result is about 6 counts in the case of the continuous double feed. Variations in peak time of the first one-sheet conveyance are reduced because the recording materials P are continuously doubly fed. However, it can be seen that variations in peak time of a portion to be doubly fed are greatly increased. Therefore, the control unit 10 can determine that the recording materials P are doubly fed.

It can be seen that the difference between the first measurement result and the sixth measurement result as the difference between the peak times calculated from the first measurement result and the second or subsequent measurement result is about 10 counts in the case of the tight double feed. It can be seen that variations are wholly increased as compared with the peak times at the time of the one-sheet conveyance because the recording materials P are tightly and doubly fed. Therefore, the control unit 10 can determine that the recording materials P are doubly fed.

In the present exemplary embodiment, the method for obtaining the difference between the first measurement result and the second or subsequent measurement result is discussed as the method for calculating the change amount. However, the method is not restricted thereto. For example, a method for obtaining a difference between measurement results each time, and calculating an average value of the differences can also be used.

The method for extracting one time of the extracted peak in one measurement is described. However, as illustrated in FIGS. 3A, 3B, and 3C, a plurality of peaks are present in one measurement. The double feed can be determined based on a plurality of calculation results by detecting the plurality of peaks and extracting the time of each of the peaks.

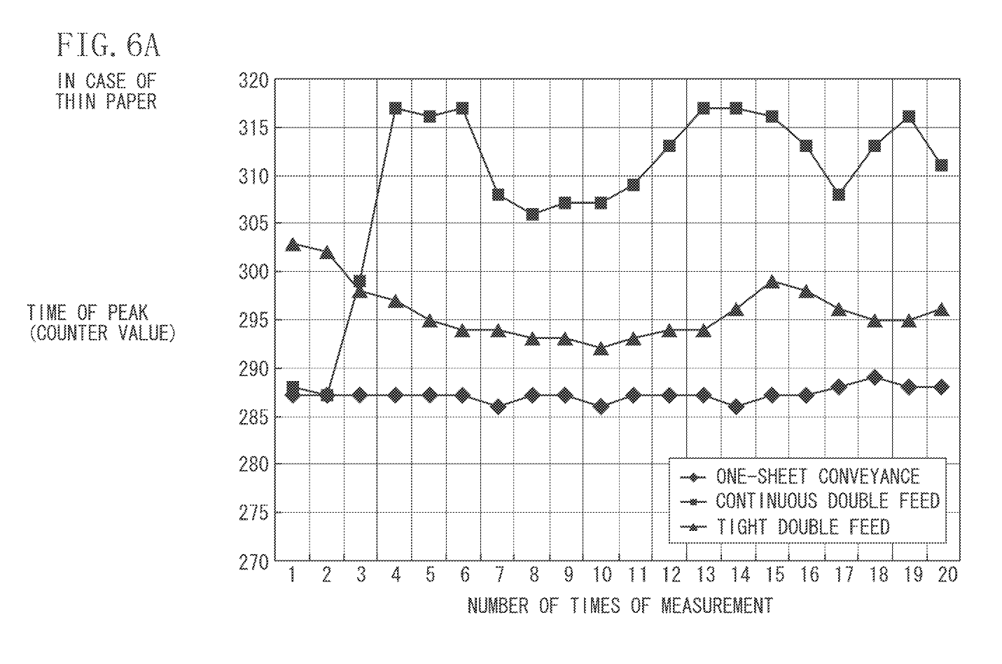

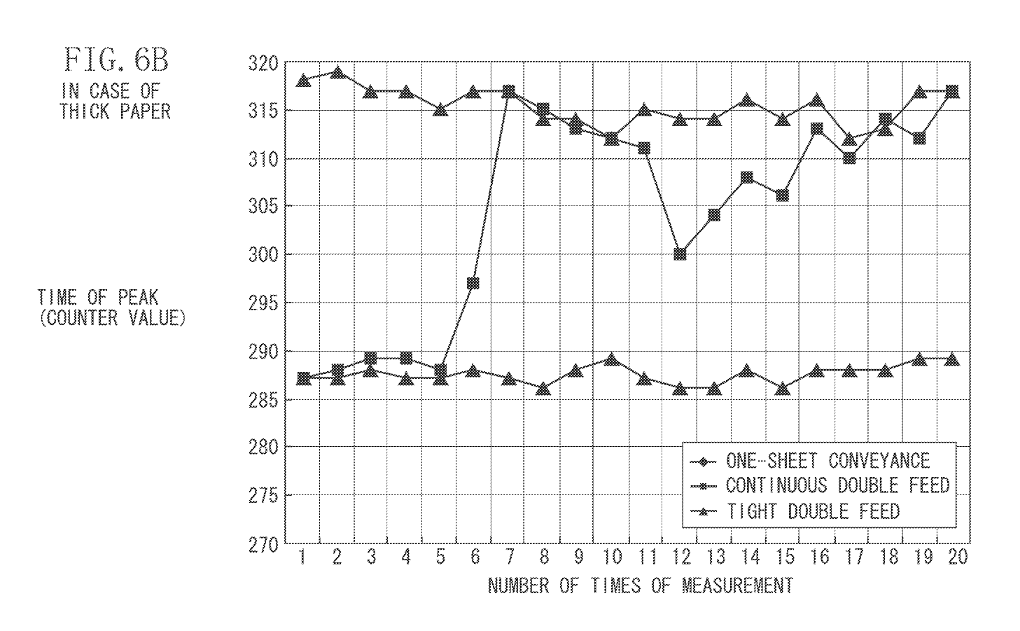

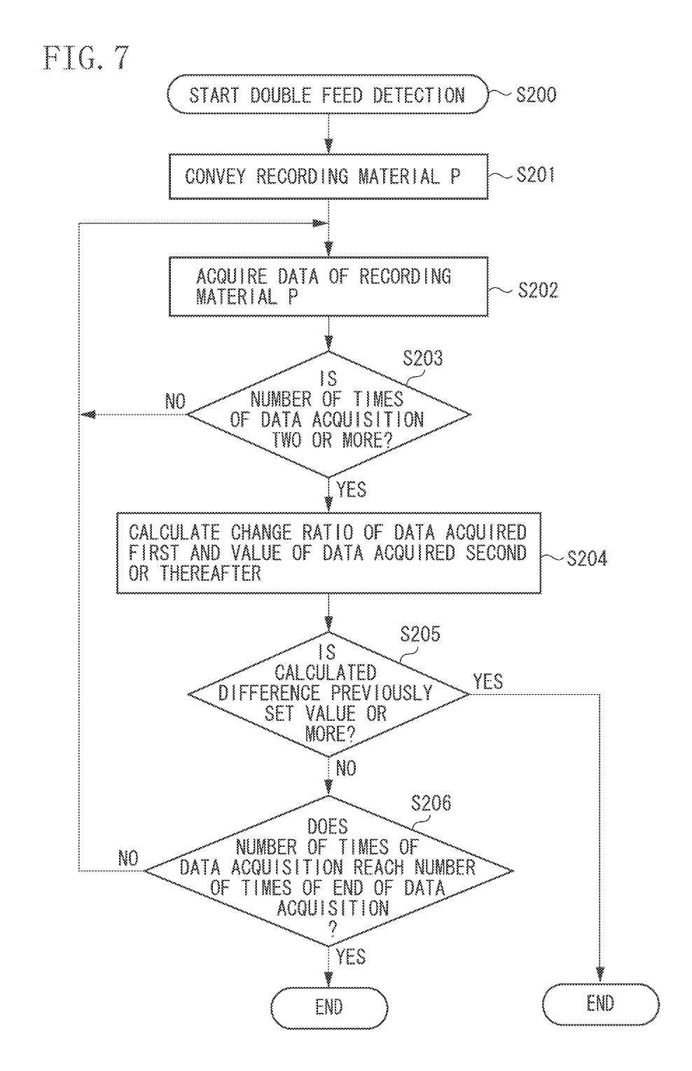

FIGS. 6A and 6B are graphs in which peak times measured when recording materials P are doubly fed and when the recording materials P are not doubly fed at wave numbers different from those of FIGS. 5A and 5B are plotted. It can be seen that the values of the peak times of FIGS. 6A and 6B are larger than those of FIGS. 5A and 5B, however, variations in times when the peaks are detected are reduced in a state where both thin paper and heavy paper are not doubly fed as in FIGS. 5A and 5B.

It can be seen that the deviation of the peak time is increased in a state where the recording materials P are doubly fed. Therefore, the double feed state of the recording materials P can be determined regardless of the wave number of the ultrasonic wave in a state where a sufficient output value is obtained. Therefore, for example, a detection method in which the first measured value is the second wave and the subsequent measured value is the third wave can also detect a state where the recording materials P are doubly fed and a state where the recording materials P are not doubly fed.

Thus, the double feed of the recording materials can be precisely determined without being influenced by the environment and the kind of the recording material by setting the double feed determination threshold value based on the difference between the peak times.

Since the difference between the peak times is not changed by the difference of the kind (basis weight) of the recording material, the double feed of thin paper or heavy paper can be certainly determined. Even when an environmental variation of an ambient temperature and humidity occurs, the double feed state can be precisely determined without calculating the difference between the peak times acquired immediately and performing an acquisition operation of correction data based on the environmental variation.

The conveyance path for conveying the recording material is designed so that the conveyance path can be opened and closed in many cases, in consideration of maintenability. Therefore, arrangement of the ultrasonic wave emitting unit and the ultrasonic wave receiving unit disposed sandwiching the conveyance path therebetween is also considered to vary.

Particularly, the variation of the distance between the ultrasonic wave emitting unit and the ultrasonic wave receiving unit greatly gives influences to the propagation time of the ultrasonic wave. However, even when the arrangement of the ultrasonic wave emitting unit and the ultrasonic wave receiving unit varies and the distance varies, the double feed state can be precisely determined without calculating the difference between the peak times acquired immediately and performing an acquisition operation of correction data based on the distance variation.

In the first exemplary embodiment, the method for determining the double feed based on the difference between the peak times of the ultrasonic wave having passed through the recording material P is described. In a second exemplary embodiment, a method for determining double feed based on a change in a peak value of an ultrasonic wave having passed through a recording material P is described. The detailed description of the same configuration as that of the first exemplary embodiment such as a recording material determination device will be omitted herein.

A method for detecting double feed of the recording materials P based on a change of a peak value of an ultrasonic wave will be described with reference to a flowchart of FIG. 7.

In step S201, a control unit 10 conveys the recording material P between an ultrasonic wave emitting unit 31 and an ultrasonic wave receiving unit 32 of a recording material determination device 30. In step S202, the control unit 10 causes the ultrasonic wave emitting unit 31 to emit the ultrasonic wave to the recording material P. The control unit 10 causes the ultrasonic wave receiving unit 32 to receive the ultrasonic wave having passed through the recording material P. The control unit 10 measures peak times from the received ultrasonic wave. The control unit 10 stores the measured results in the memory unit 346.

In step S203, the control unit 10 determines whether the number of times of data acquisition of the recording material P is 2 or more. It is necessary to calculate a change ratio of peak values to determine the double feed. Therefore, when the number of times of data acquisition is 1 (NO in step S203), the processing returns to step S202, and the control unit 10 acquires data again. When the number of times of data acquisition is 2 or more (YES in step S203), in step S204, the control unit 10 calculates a change ratio of data first acquired and data acquired second or thereafter.

In step S205, the control unit 10 compares the value calculated in step S204 with a previously set value. As a result of the comparison, when the calculated value is smaller than the set value (NO in step S205), the control unit 10 determines that the recording materials P are not doubly fed, and the processing proceeds to step S206. When the calculated value is larger than the set value (YES in step S205), the control unit 10 determines that the recording materials P are doubly fed, and ends the processing.

In step S206, the control unit 10 determines whether the number of times of data acquisition reaches the number of times of end of data acquisition. When the number of times of data acquisition does not reach the number of times of end of data acquisition (NO in step S206), the processing returns to step S202, and the control unit 10 acquires data again. When the number of times of data acquisition reaches the number of times of end of data acquisition (YES in step S206), the control unit 10 determines that the recording materials P are not doubly feed, and ends the processing.

In the present exemplary embodiment, as an example, the number of times of end of data acquisition is set to 20. This number of times is the number of times of measurement sufficiently acquirable while the recording material P is present between the ultrasonic wave emitting unit 31 and the ultrasonic wave receiving unit 32. The upper limit of the number of times of measurement can be appropriately set from a conveyance speed of the recording material P and a time when received data of the ultrasonic wave is acquired.

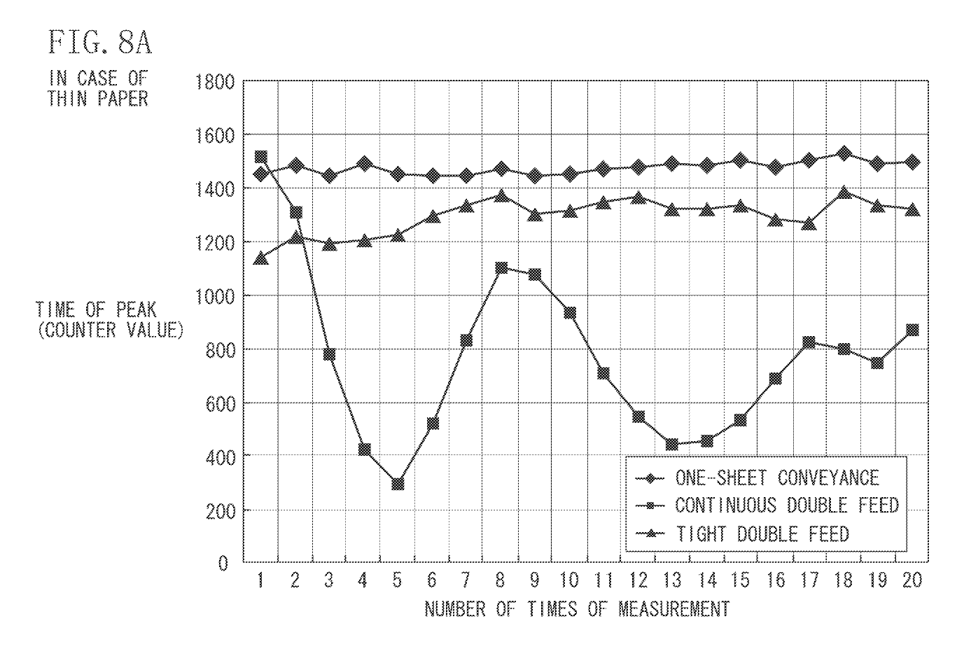

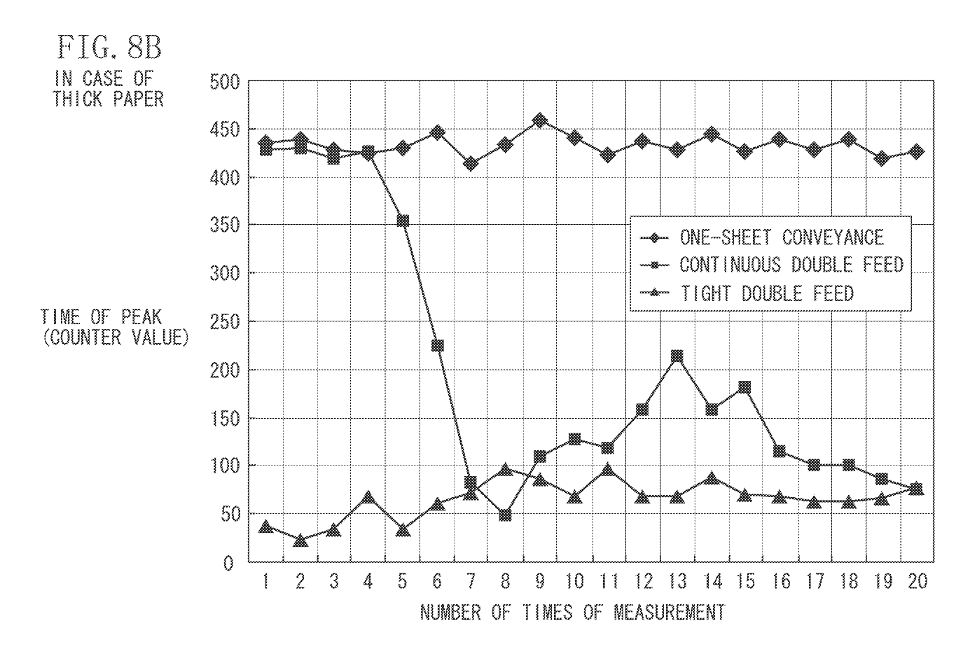

FIGS. 8A and 8B are graphs in which peak values measured when the recording materials P are doubly fed and when the recording materials P are not doubly fed are plotted. The recording material P used in FIG. 8A has a basis weight of 60 g/m². The recording material P used in FIG. 8B has a basis weight of 160 g/m². A value which is a double feed determination threshold value is set to 10%. The double feed determination threshold value is an example in the present exemplary embodiment, and can be appropriately set by the cycle of a counter or the sampling cycle of an A-D conversion unit.

In FIG. 8A, in a case of one-sheet conveyance, the change ratio of the peak values calculated from the first measurement result and the second or subsequent measurement result is up to about 8%. Since variations in the values of the peak are reduced in a state where the recording materials P are not doubly fed, the control unit 10 can determine that the recording materials P are not doubly fed.

In the case of continuous double feed, it can be seen that the change ratio of the first measurement result and the second measurement result as the change ratio of the peak value calculated from the first measurement result and the second or subsequent measurement result is about 13%. Therefore, the control unit 10 can determine that the recording materials P are doubly fed.

In the case of tight double feed, it can be seen that the change ratio of the first measurement result and the sixth measurement result as the change ratio of the peak values calculated from the first measurement result and the second or subsequent measurement result is about 12%. Therefore, the control unit 10 can determine that the recording materials P are doubly fed.

In FIG. 8B, in the case of the one-sheet conveyance, the change ratio of the peak values calculated from the first measurement result and the second or subsequent measurement result is up to about 7%. Since variations in the change ratio of the peak values are reduced in a state where the recording materials P are not doubly fed, the control unit 10 can determine that the recording materials P are not doubly fed.

In the case of the continuous double feed, it can be seen that the change ratio of the peak values calculated from the first measurement result and the fifth measurement result as the change ratio of the peak values calculated from the first measurement result and the second or subsequent measurement result is about 17%. Therefore, the control unit 10 can determine that the recording materials P are doubly fed.

In the case of the tight double feed, it can be seen that the change ratio of the peak values calculated from the first measurement result and the fourth measurement result as the change ratio of the peak values calculated from the first measurement result and the second or subsequent measurement result is about 22%. Therefore, the control unit 10 can determine that the recording materials P are doubly fed.

In the present exemplary embodiment, the method for obtaining the change ratio of the first measurement result and the second or subsequent measurement result is discussed as the method for calculating the change ratio. However, the method is not restricted thereto. For example, a method for obtaining a change ratio of a measurement result each time, and calculating an average value of the change ratios can also be used.

The method for extracting one value of the extracted peak in one measurement is described. However, as illustrated in FIG. 3, a plurality of peaks are present in one measurement. The double feed can be determined based on a plurality of calculation results by detecting the plurality of peaks and extracting the value of each of the peaks.

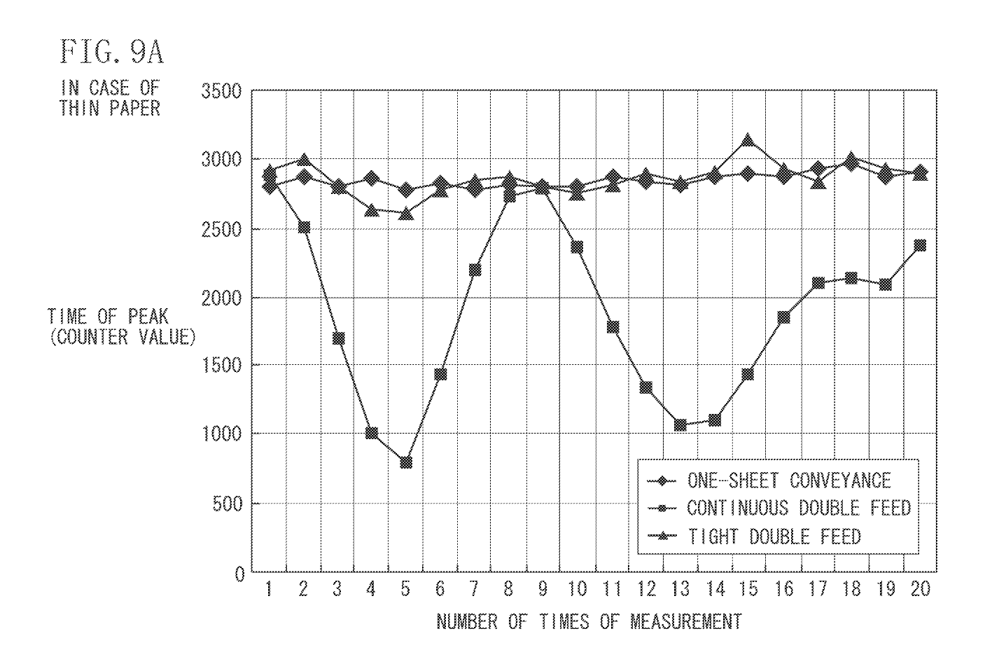

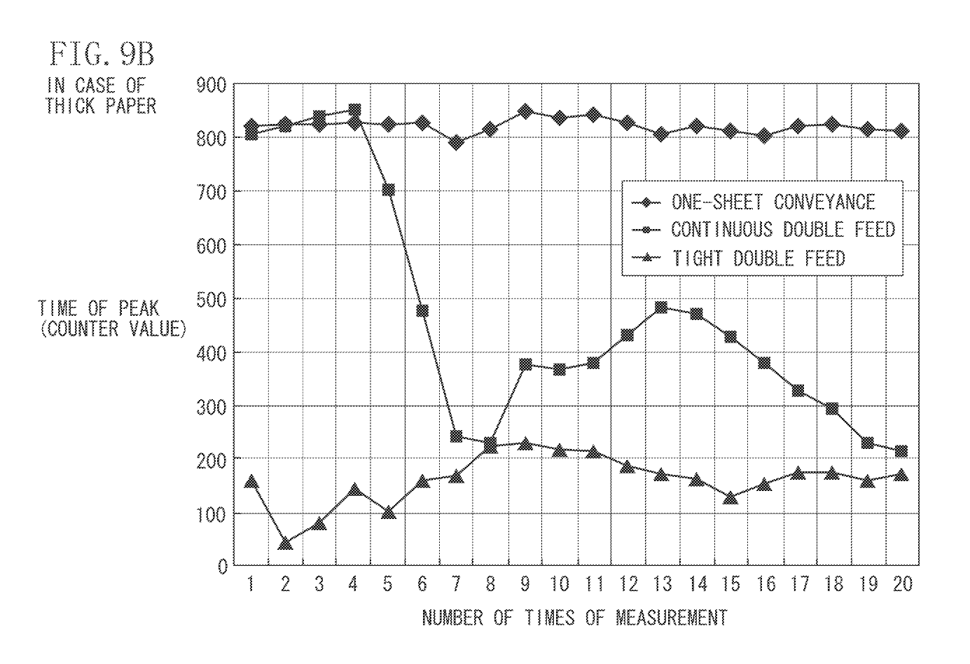

FIGS. 9A and 9B are graphs in which peak values measured when recording materials P are doubly fed and when the recording materials P are not doubly fed at wave numbers different from those of FIGS. 8A and 8B are plotted. It can be seen that the peak values of FIGS. 9A and 9B are larger than those of FIGS. 8A and 8B, however, variations in the peak values are reduced in a state where both thin paper and heavy paper are not doubly fed as in FIGS. 8A and 8B.

It can be seen that the variation of the peak value is increased in a state where the recording materials P are doubly fed. Therefore, the double feed state of the recording materials P can be determined regardless of the wave number of the ultrasonic wave in a state where a sufficient output value is obtained. Therefore, for example, a detection method in which the first measured value is the second wave and the subsequent measured value is the third wave can also detect a state where the recording materials P are doubly fed and a state where the recording materials P are not doubly fed.

Thus, the double feed of the recording materials can be precisely determined without being influenced by environment and the kind of the recording material by setting the double feed determination threshold value based on the change ratio of the peak values.

Since the change ratio of the peak values is a value according to the kind (basis weight) of the recording material, the value of the obtained peak itself is greatly changed by the basis weight of the recording material. However, since the change ratio of the peak values during the one-sheet conveyance and during the double feed is not changed even when the basis weight of the recording material is different, the double feed can be precisely determined regardless of the kind of the recording material.

Even when an environmental variation of an ambient temperature and an atmospheric pressure occurs, the double feed state can be precisely determined without calculating the change ratio of the peak values acquired immediately and performing an acquisition operation of correction data based on the environmental variation.

In the first exemplary embodiment, the method for determining the double feed based on the difference between the peak times of the ultrasonic wave having passed through the recording material P is described. In a third exemplary embodiment, a method for determining double feed based on a change amount of peak times of an ultrasonic wave having passed through a recording material P to peak times of the ultrasonic wave received in a state where the recording material P is not present between an ultrasonic wave emitting unit 31 and an ultrasonic wave receiving unit 32 is described. The detailed description of the same configuration as that of the first exemplary embodiment such as a recording material determination device will be omitted herein.

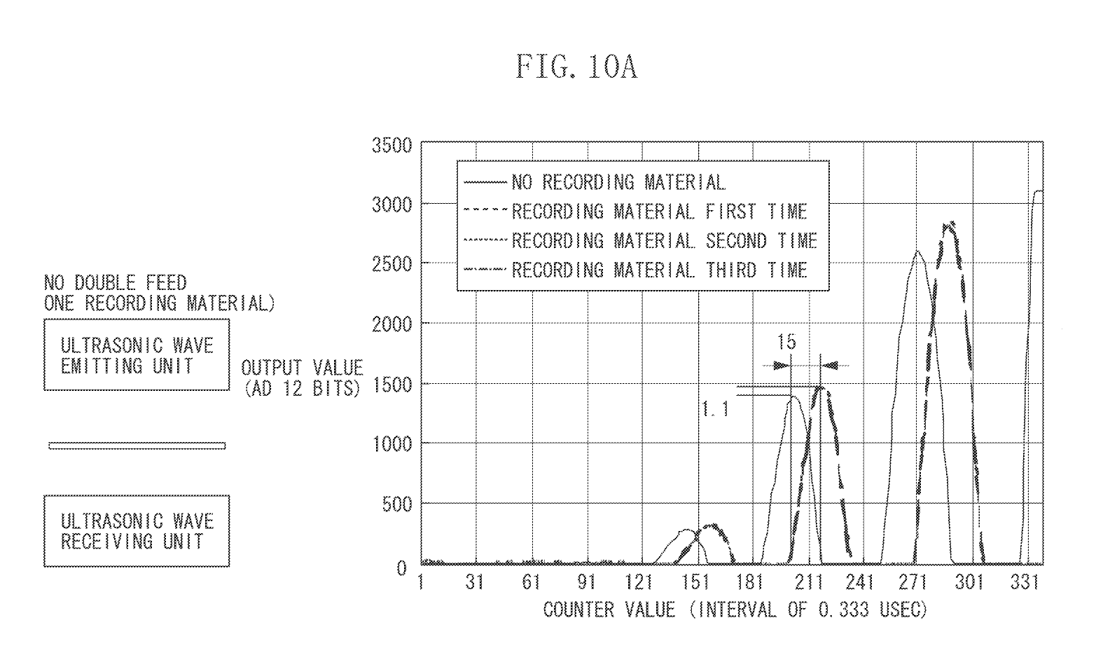

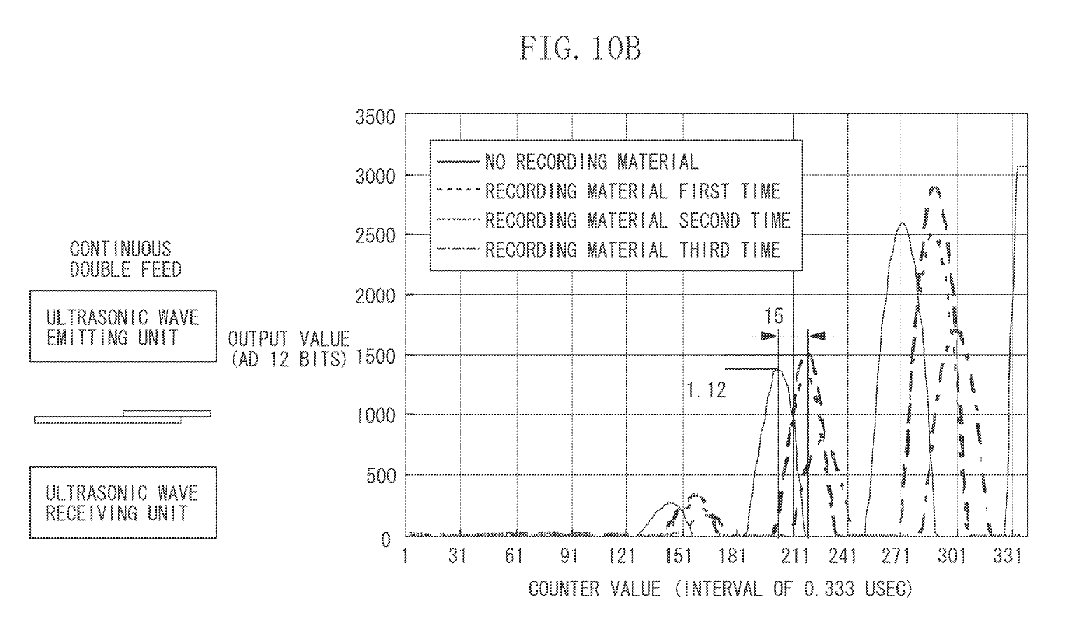

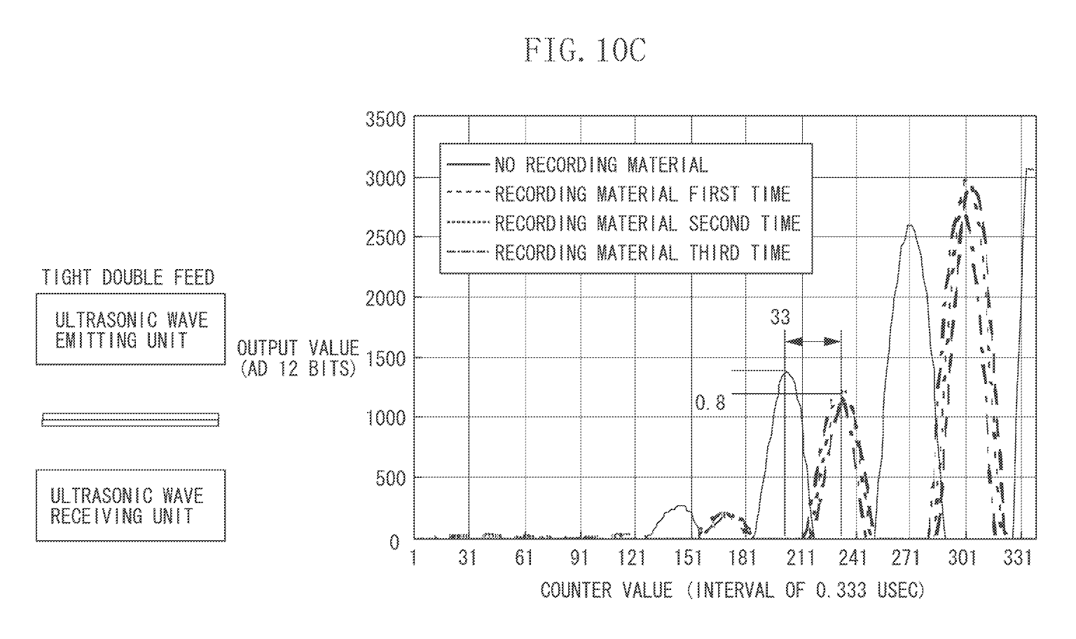

A waveform of a received signal of an ultrasonic wave having passed through a recording material P in the present exemplary embodiment is illustrated in FIGS. 10A, 10B, and 10C. FIGS. 10A, 10B, and 10C illustrate the waveform of the received signal of the ultrasonic wave in a state where the recording material is not present between the ultrasonic wave emitting unit 31 and the ultrasonic wave receiving unit 32, and the waveform of the received signal of the ultrasonic wave having passed through the recording material P. The used recording material has a basis weight of 60 g/m².

FIG. 10A illustrates data when one recording material P is conveyed. FIG. 10B illustrates data when the recording materials P are continuously and doubly feed. FIG. 10C illustrates data when the recording materials Pare tightly and doubly fed. In each data, three measured waveforms are illustrated with the waveforms being overlapped.

It can be seen that when one recording material P is conveyed, variations in a ratio of peak values measured more than once and a difference between peak times are very small.

It can be seen that when the recording materials P are continuously and doubly fed, the peak values are attenuated as compared with the case where the recording materials P are not doubly fed, and times when the peaks appear are delayed. It can be seen that three measurement results vary.

It can be seen that when the recording materials P are tightly and doubly fed, the peak values are attenuated as compared with the case where the recording materials P are not doubly fed, and times when the peaks appear are delayed. It can be seen that three measurement results vary. Therefore, the double feed of the recording materials P can be determined based on the change amount of each of the measurement results of the recording materials P measured more than once.

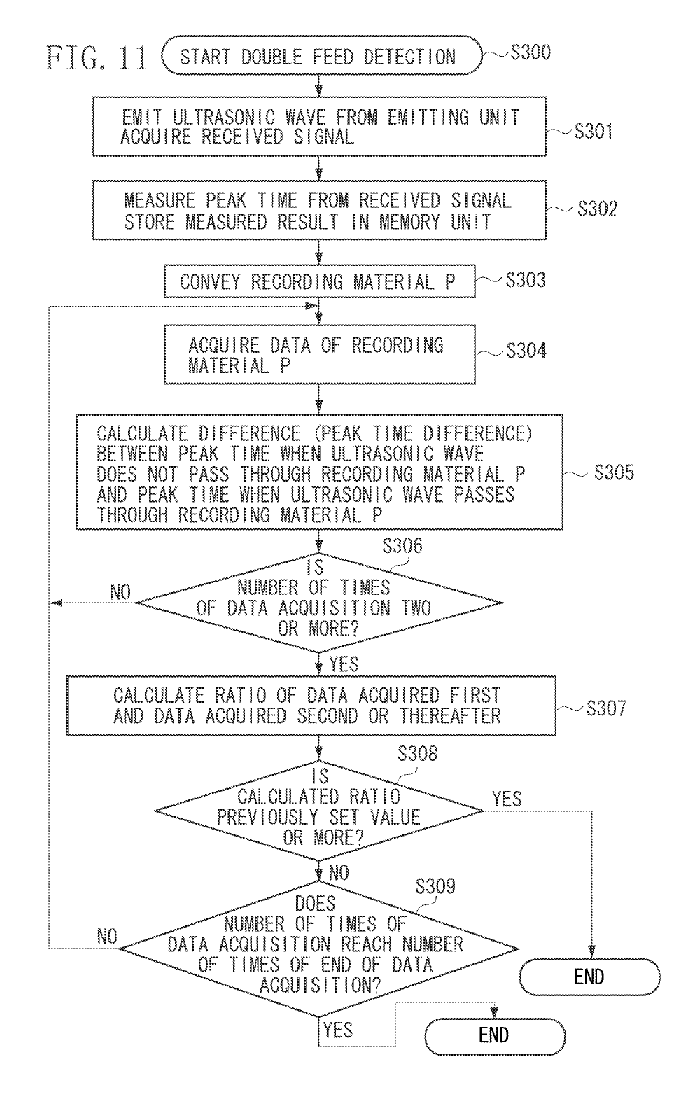

Subsequently, a method for detecting double feed of the recording materials P based on a change amount of peak times of an ultrasonic wave will be described with reference to a flowchart of FIG. 11.

In step S301, a control unit 10 causes the ultrasonic wave emitting unit 31 to emit the ultrasonic wave in a state where the recording material P is not present between the ultrasonic wave emitting unit 31 and the ultrasonic wave receiving unit 32. The ultrasonic wave receiving unit 32 receives the ultrasonic wave. In step S302, the control unit 10 measures peak times from the received ultrasonic wave. The control unit 10 stores the measured results in the memory unit 346.

In step S303, the control unit 10 conveys the recording material P between the ultrasonic wave emitting unit 31 and the ultrasonic wave receiving unit 32 of a recording material determination device 30. In step S304, the control unit 10 causes the ultrasonic wave emitting unit 31 to emit the ultrasonic wave to the recording material P. The ultrasonic wave receiving unit 32 receives the ultrasonic wave having passed through the recording material P. The control unit 10 measures peak times from the received ultrasonic wave. The control unit 10 stores the measured results in the memory unit 346.

In step S305, the control unit 10 calculates a difference between the peak time when the ultrasonic wave has not passed through the recording material P obtained in step S302 and the peak time obtained in step S304 when the ultrasonic wave has passed through the recording material P, as a peak time difference.

In step S306, the control unit 10 determines whether the number of times of data acquisition of the recording material P is 2 or more. Since it is necessary to calculate a ratio of the peak time difference to determine the double feed. Therefore, it is necessary to measure data more than once. When the number of times of data acquisition is 1 (NO in step S306), the processing returns to step S304, and the control unit 10 acquires data again.

In step S307, the control unit 10 calculates a ratio of data first acquired and data acquired second or thereafter. When the peak time difference between the peak time when the ultrasonic wave has not passed through the recording material P and the peak time of the first measurement result is obtained on the conditions of FIGS. 5A and 10, the peak time difference in one-sheet conveyance is about 15 counts, the peak time difference in continuous double feed is about 15 counts, and the peak time difference in tight double feed is about 32 counts.

A ratio of the peak time difference and a peak time difference between the peak times when the ultrasonic wave has not passed through the recording material P and data acquired second or thereafter is obtained. Since a difference between the peak time difference of the first measurement result and the peak time difference of the second or subsequent measurement result is about 1 count in the one-sheet conveyance, the ratio is set to 1.0 to about 1.06.

Since a difference between the peak time difference of the first measurement result and the peak time difference of the second or subsequent measurement result is about 30 counts in the continuous double feed, the ratio is set to 1.0 to about 3.0. Since a difference between the peak time difference of the first measurement result and the peak time difference of the second or subsequent measurement result is about −12 counts to about 13 counts in the tight double feed, the ratio is set to about 0.6 to about 1.4. Thus, when the recording material P is in a double feed state, a change in the ratio of the peak time difference is increased.

In step S308, the control unit 10 compares the ratio calculated in step S307 with a previously set threshold value. The threshold value is set to, for example, 1.0±0.15. When the threshold value exceeds this range, the control unit 10 can determine that the recording materials P are doubly fed. This threshold value can be appropriately set according to the determination accuracy of the double feed.

As a result of the comparison, when the calculated value does not exceed the threshold value (NO in step S308), the control unit 10 determines that the recording materials P are not doubly fed, and the processing proceeds to step S309. When the calculated ratio exceeds the threshold value (YES in step S308), the control unit 10 determines that the recording materials P are doubly fed, and ends the processing.

In step S309, the control unit 10 determines whether the number of times of data acquisition reaches the number of times of end of data acquisition. When the number of times of data acquisition does not reach the number of times of end of data acquisition (NO in step S309), the processing returns to step S304, and the control unit 10 acquires data again. When the number of times of data acquisition reaches the number of times of end of data acquisition (YES in step S309), the control unit 10 determines that the recording materials P are not doubly feed, and ends the processing. This method can determine whether the recording materials P are doubly fed as in the first exemplary embodiment.

Thus, the double feed of the recording materials can be precisely determined without being influenced by the environment and the kind of the recording material by setting a double feed determination threshold value based on the change amount of the peak time difference. The influence of the arrangement variation of the ultrasonic wave emitting unit 31 and the ultrasonic wave receiving unit 32 can be reduced by using the ratio of the difference between the measurement result in a state where the recording material P is not present between the ultrasonic wave emitting unit 31 and the ultrasonic wave receiving unit 32 and the measurement result in a state where the recording material P is present, and the double feed can be precisely determined.

In the second exemplary embodiment, the method for determining the double feed based on the difference between the peak values of the ultrasonic wave having passed through the recording material P is described. In a fourth exemplary embodiment, a method for determining double feed based on a change amount of peak values of an ultrasonic wave having passed through a recording material P to peak values of the ultrasonic wave received in a state where the recording material P is not present between an ultrasonic wave emitting unit 31 and an ultrasonic wave receiving unit 32 will be described.

The detailed description of the same configuration as that of the first exemplary embodiment such as a recording material determination device will be omitted herein. Since the waveform of the received signal of the ultrasonic wave having passed through the recording material P is the same as those of FIGS. 10A, 10B, and 10C of the third exemplary embodiment, the detailed description thereof will be omitted.

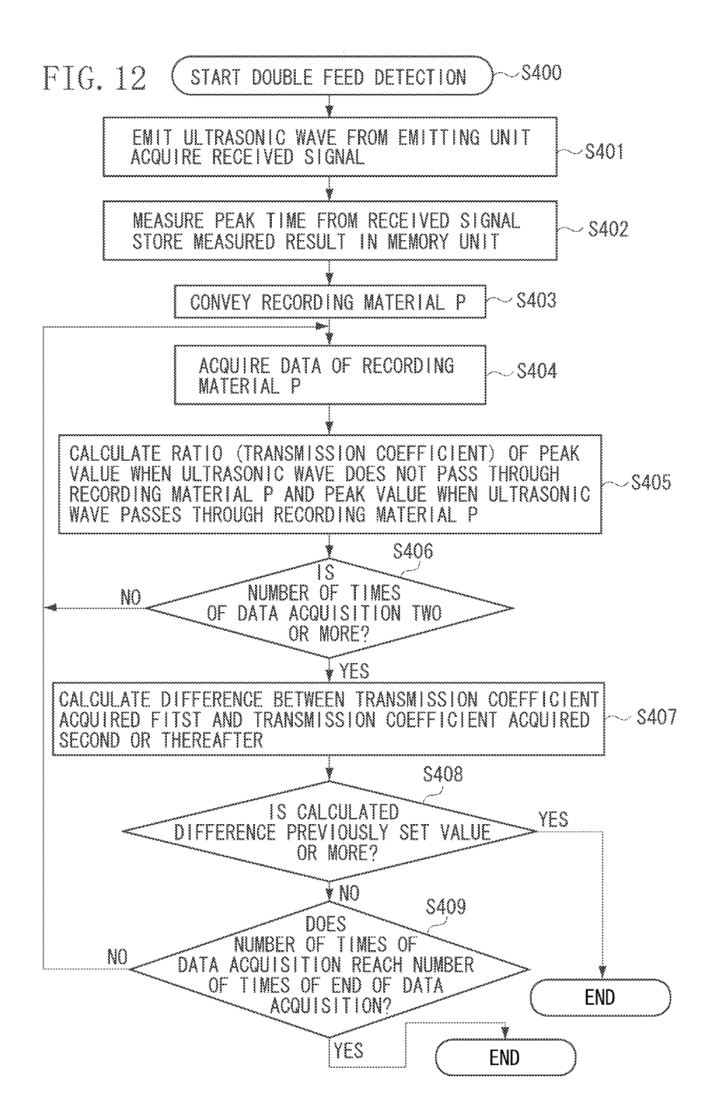

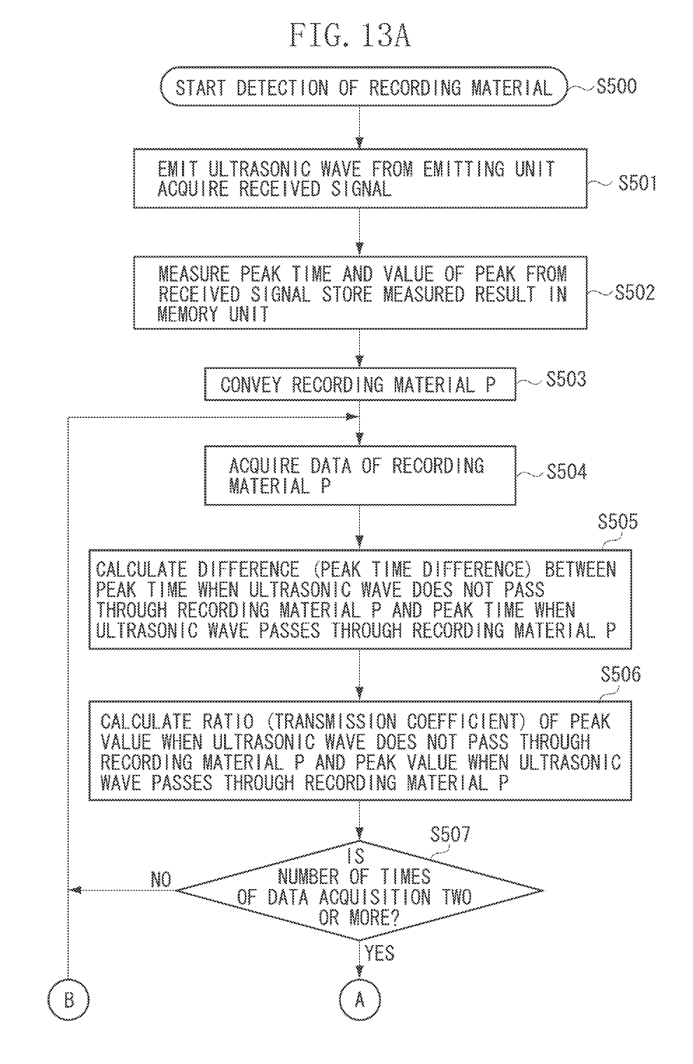

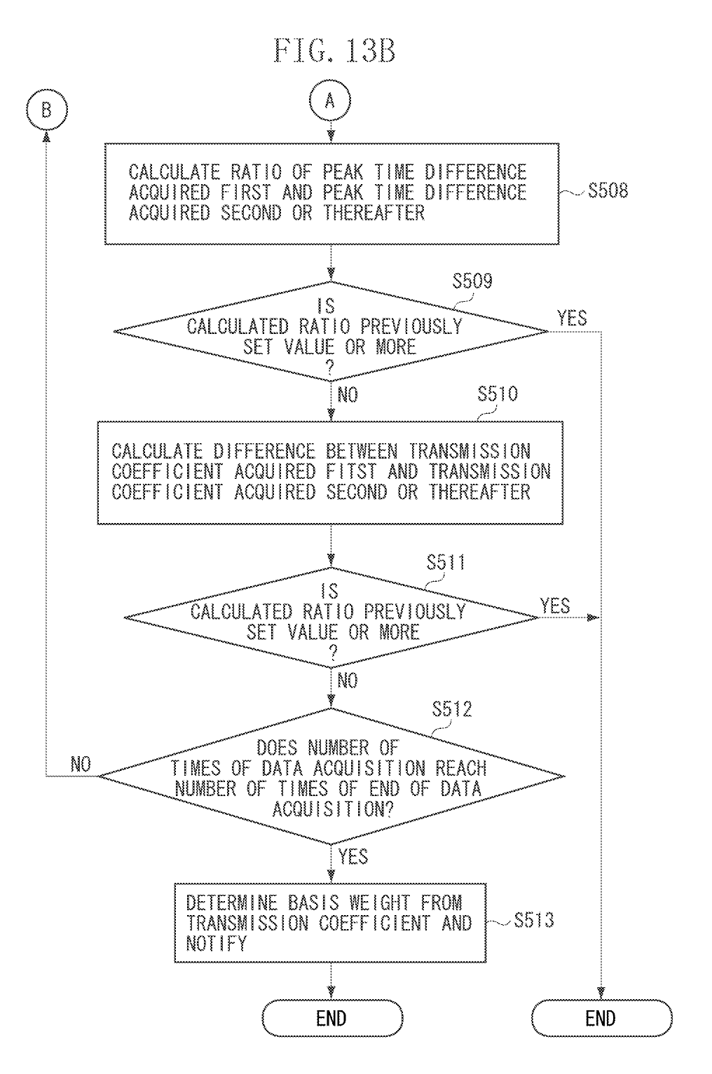

Next, a method for detecting double feed of recording materials P based on a change amount of a peak value of an ultrasonic wave will be described with reference to a flowchart of FIG. 12.

In step S401, the control unit 10 causes the ultrasonic wave emitting unit 31 to emit the ultrasonic wave in a state where the recording material P is not present between the ultrasonic wave emitting unit 31 and the ultrasonic wave receiving unit 32. The ultrasonic wave receiving unit 32 receives the ultrasonic wave. In step S402, the control unit 10 measures peak values from the received ultrasonic wave. The control unit 10 stores the measured results in the memory unit 346.

In step S403, the control unit 10 conveys the recording material P between the ultrasonic wave emitting unit 31 and the ultrasonic wave receiving unit 32 of a recording material determination device 30. In step S404, the control unit 10 causes the ultrasonic wave emitting unit 31 to emit the ultrasonic wave to the recording material P. The ultrasonic wave receiving unit 32 receives the ultrasonic wave having passed through the recording material P. The control unit 10 measures peak values from the received ultrasonic wave. The control unit 10 stores the measured results in the memory unit 346.

In step S405, the control unit 10 calculates a ratio of the peak value obtained in step S402 when the ultrasonic wave has not passed through the recording material P and the peak value obtained in step S404 when the ultrasonic wave has passed through the recording material P as a transmission coefficient.

In step S406, the control unit 10 determines whether the number of times of data acquisition of the recording material P is 2 or more. Since it is necessary to calculate a change ratio of the transmission coefficient to determine the double feed, it is necessary to measure data more than once. When the number of times of data acquisition is 1 (NO in step S406), the processing returns to step S404, and the control unit 10 acquires data again.

In step S407, the control unit 10 calculates a ratio of data first acquired and data acquired second or thereafter. When a transmission coefficient of the peak value when the ultrasonic wave has not passed through the recording material P and the peak value of the first measurement result is obtained on the conditions of FIGS. 8A, 10A, 10B, and 10C. The transmission coefficient in one-sheet conveyance is about 1.1, the transmission coefficient in continuous double feed is about 1.2, and the transmission coefficient in tight double feed is about 0.8. A difference between this transmission coefficient and a transmission coefficient of the peak value when the ultrasonic wave has not passed through the recording material P and the peak value of the data acquired second or thereafter is obtained.

Since there are substantially no difference between the transmission coefficient of the first measurement result and the transmission coefficient of the second or subsequent measurement result in the one-sheet conveyance, the difference is set to about 0.0. A difference between the transmission coefficient of the first measurement result and the transmission coefficient of the second or subsequent measurement result in the continuous double feed is about 0.0 to about −0.9. A difference between the transmission coefficient of the first measurement result and the transmission coefficient of the second or succeeding measurement result in the tight double feed is about 0.8 to about 0.9. Thus, when the recording material P is in a double feed state, the difference between the transmission coefficients is increased.

In step S408, the control unit 10 compares the difference calculated in step S407 with a previously set threshold value. The threshold value is set to, for example, ±0.05. When the threshold value exceeds this range, the control unit 10 can determine that the recording materials P are doubly fed. This threshold value can be appropriately set according to the determination accuracy of the double feed.

As a result of the comparison, when the calculated difference does not exceed the threshold value (NO in step S408), the control unit 10 determines that the recording materials P are not doubly fed, and the processing proceeds to step S409. When the calculated difference exceeds the threshold value (YES in step S408), the control unit 10 determines that the recording materials P are doubly fed, and ends the processing.

In step S409, the control unit 10 determines whether the number of times of data acquisition reaches the number of times of end of data acquisition. When the number of times of data acquisition does not reach the number of times of end of data acquisition (NO in step S409), the processing returns to step S404, and the control unit 10 acquires data again. When the number of times of data acquisition reaches the number of times of end of data acquisition (YES in step S409), the control unit 10 determines that the recording materials P are not doubly feed, and ends the processing. This method can determine whether the recording materials P are doubly fed as in the second exemplary embodiment.

Thus, the double feed of the recording materials can be precisely determined without being influenced by the environment and the kind of the recording material by setting a double feed determination threshold value based on the change amount of the transmission coefficient. The influence of the arrangement variation of the ultrasonic wave emitting unit 31 and the ultrasonic wave receiving unit 32 can be reduced by using the ratio of the measurement result in a state where the recording material P is not present between the ultrasonic wave emitting unit 31 and the ultrasonic wave receiving unit 32 and the measurement result in a state where the recording material P is present, and the double feed can be precisely determined.

In the first to fourth exemplary embodiments, the method for detecting the double feed state of the recording materials P is described. In a fifth exemplary embodiment, a method for determining double feed based on a peak time difference of an ultrasonic wave having passed through a recording material P, and a change amount of a peak value, and detecting a basis weight of the recording material P from a result measured when determining that the recording materials P are not doubly fed will be described. The detailed description of the same configuration as that of the first exemplary embodiment such as a recording material determination device will be omitted herein.

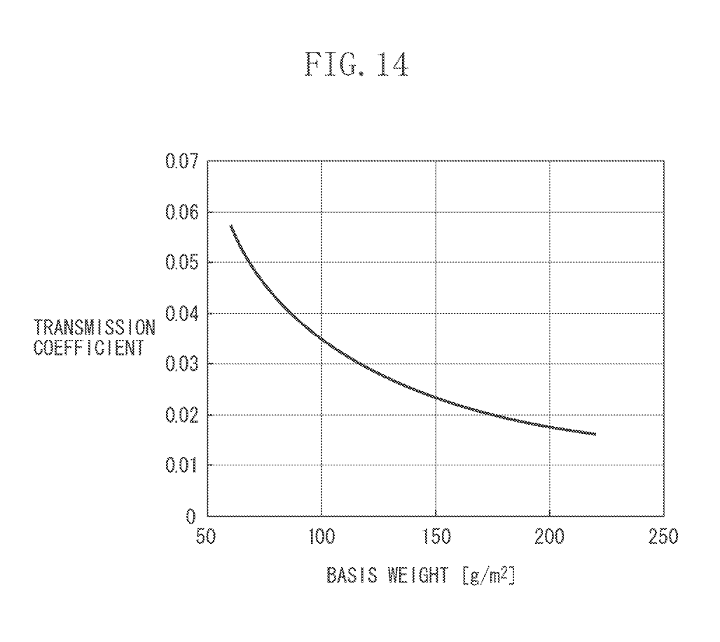

A method for detecting a double feed state and a basis weight of a recording material P will be described with reference to a flowchart of FIG. 13 (13A+13B).

In step S501, the control unit 10 causes an ultrasonic wave emitting unit 31 to emit an ultrasonic wave in a state where the recording material P is not present between the ultrasonic wave emitting unit 31 and an ultrasonic wave receiving unit 32. The ultrasonic wave receiving unit 32 receives the ultrasonic wave. In step S502, the control unit 10 measures a time and a peak value from the received ultrasonic wave. The control unit 10 stores the measured results in the memory unit 346.

In step S503, the control unit 10 conveys the recording material P between the ultrasonic wave emitting unit 31 and the ultrasonic wave receiving unit 32 of a recording material determination device 30. In step S504, the control unit 10 causes the ultrasonic wave emitting unit 31 to emit the ultrasonic wave to the recording material P. The ultrasonic wave receiving unit 32 receives the ultrasonic wave having passed through the recording material P. The control unit 10 measures peak times and peak values from the received ultrasonic wave. The control unit 10 stores the measured results in the memory unit 346.

In step S505, the control unit 10 calculates a difference between the peak time obtained in step S502 when the ultrasonic wave has not passed through the recording material P and the peak time obtained in step S504 when the ultrasonic wave has passed through the recording material P as a peak time difference. In step S506, the control unit 10 calculates a transmission coefficient, which is a change ratio of the peak value obtained in step S502 when the ultrasonic wave has not passed through the recording material P and the peak value obtained in step S504 when the ultrasonic wave has passed through the recording material P.

In step S507, the control unit 10 determines whether the number of times of data acquisition of the recording material P is 2 or more. It is necessary to calculate the peak time difference and the transmission coefficient to determine the double feed. Therefore, when the number of times of data acquisition is 1 (NO in step S507), the processing returns to step S504, and the control unit 10 acquires data again. When the number of times of data acquisition is 2 or more (YES in step S507), in step S508, the control unit 10 calculates a ratio of a peak time difference which is a difference between the peak time first acquired and the data acquired second or thereafter.

In step S509, the control unit 10 compares the ratio calculated in step S508 with a previously set threshold value. As a result of the comparison, when the calculated ratio does not exceed the threshold value (NO in step S509), the control unit 10 determines that the recording materials P are not doubly fed, and the processing proceeds to step S510. When the calculated ratio exceeds the threshold value (YES in step S509), the control unit 10 determines that the recording materials P are doubly fed, and ends the processing.

In step S510, the control unit 10 calculates a difference between the transmission coefficient calculated from the peak value first acquired and the transmission coefficient calculated from the peak value acquired second or thereafter.

In step S511, the control unit 10 compares the difference calculated in step S510 with a previously set threshold value. As a result of the comparison, when the calculated difference does not exceed the threshold value (NO in step S511), the control unit 10 determines that the recording materials P are not doubly fed, and the processing proceeds to step S512. When the calculated difference exceeds the threshold value (YES in step S511), the control unit 10 determines that the recording materials P are doubly fed, and ends the processing.

In step S512, the control unit 10 determines whether the number of times of data acquisition reaches the number of times of end of data acquisition. When the number of times of data acquisition does not reach the number of times of end of data acquisition (NO in step S512), the processing returns to step S504, and the control unit 10 acquires data again. When the number of times of data acquisition reaches the number of times of end of data acquisition (YES in step S512), the control unit 10 determines that the recording materials P are not doubly feed.

In step S513, the control unit 10 detects a basis weight of the recording material based on the transmission coefficient calculated more than once in step S506. First, the control unit 10 obtains an average value of the transmission coefficients for the measured number of times. The control unit 10 corrects the average value of the transmission coefficients using a ratio of a peak value previously obtained under a known environment and the peak value measured in step S502 in a state where the recording material P is not present between the ultrasonic wave emitting unit 31 and the ultrasonic wave receiving unit 32, as a correction coefficient.

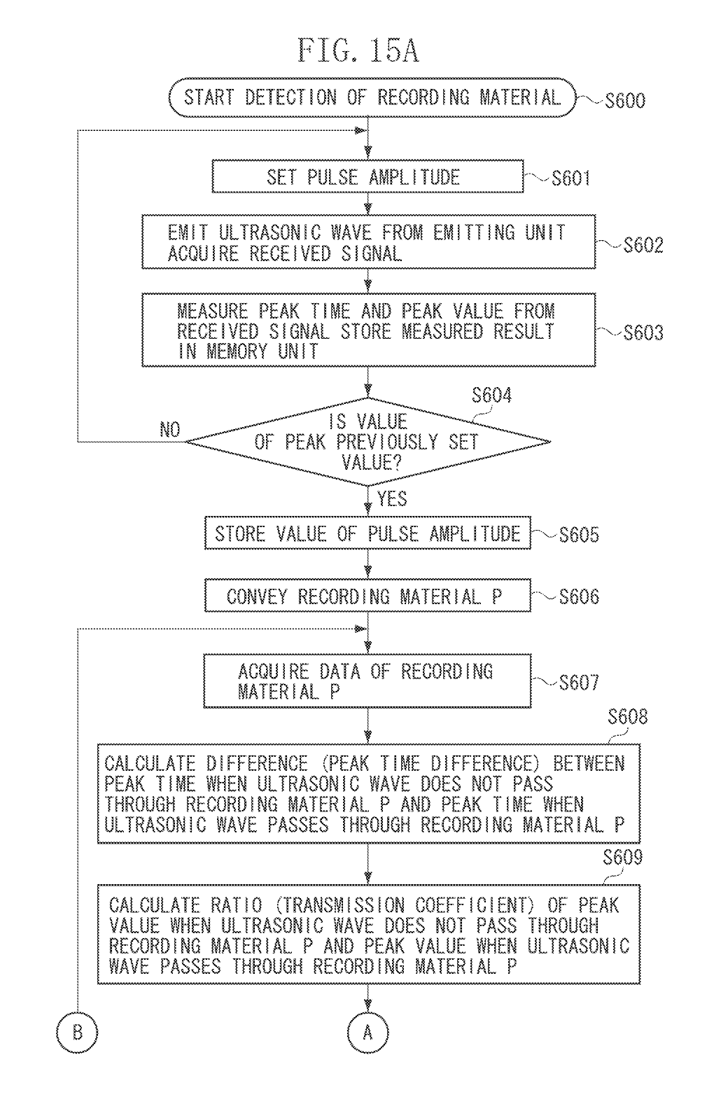

A method for setting the correction coefficient is an example according to the present exemplary embodiment. The correction coefficient can be appropriately set in consideration of an ambient environmental variation and arrangement of a sensor. The basis weight of the conveyed recording material is detected from the relation between the basis weight and the transmission coefficient of the recording material P illustrated in FIG. 14 using the corrected transmission coefficient.

The method for extracting a time and a value of the extracted peak in one measurement is described. As illustrated in FIGS. 3A, 3B, and 3C, a plurality of peaks are present in one measurement. The plurality of peaks are detected, and the time and the value of each of the peaks are extracted, and thereby the double feed can be determined and the basis weight of the recording material can be detected based on a plurality of calculation results.

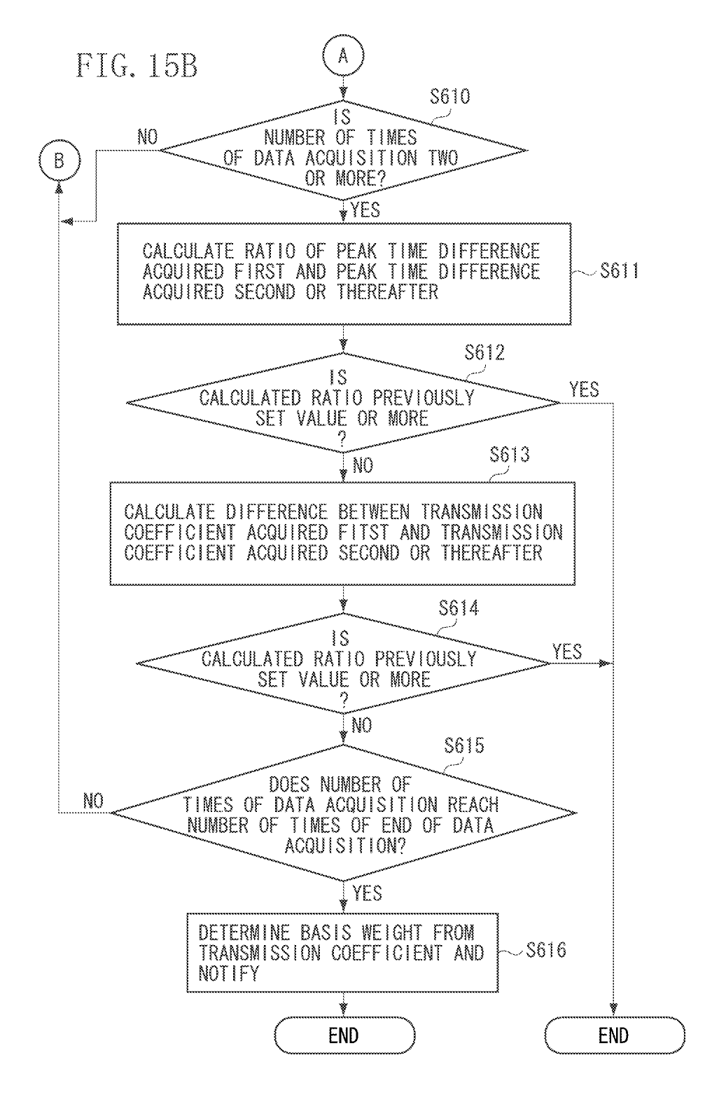

Another method for an adjustment and a correction operation when the basis weight is detected will be described in detail with reference to a flowchart of FIG. 15.

The ultrasonic wave is corrected by using a configuration for adjusting the amplitude of the ultrasonic wave. The amplitude of the ultrasonic wave is adjusted by changing a value of pulse amplitude configured in the control unit 10. The value of the pulse amplitude corresponds to an amplification level of a signal level of an amplifier 332. The sound pressure of the ultrasonic wave emitted from the ultrasonic wave emitting unit 31 can be adjusted by changing this pulse amplitude.

In step S601, the control unit 10 sets the pulse amplitude for driving the ultrasonic wave emitting unit 31. In step S602, the control unit 10 causes the ultrasonic wave emitting unit 31 to emit the ultrasonic wave to the recording material P in a state where the recording material P is not present between the ultrasonic wave emitting unit 31 and the ultrasonic wave receiving unit 32. The ultrasonic wave receiving unit 32 receives the ultrasonic wave. In step S603, the control unit 10 measures times and peak values from the received signal. The control unit 10 stores the measured results in the memory unit 346.

In step S604, the control unit 10 compares the peak value obtained in step S603 with a previously set value. As a result of the comparison, when the peak value is within a range of ±3% of the set value (YES in step S604), the control unit 10 ends the adjustment of the pulse amplitude, and the processing proceeds to step S605. When the peak value is not within the range (NO in step S604), the processing returns to step S601 again, and the control unit 10 adjusts the value of the pulse amplitude set in step S601 so as to bring the peak value closer to the set value. In step S605, the control unit 10 stores the value set in step S601 in the memory unit 346.

In step S606, the control unit 10 conveys the recording material P between the ultrasonic wave emitting unit 31 and the ultrasonic wave receiving unit 32 of the recording material determination device 30. In step S607, the control unit 10 emits the ultrasonic wave to the recording material P. The ultrasonic wave receiving unit 32 receives the ultrasonic wave having passed through the recording material P. The control unit 10 measures times and peak values from the received signal. The control unit 10 stores the measured results in the memory unit 346.

In step S608, the control unit 10 calculates a difference between the peak time obtained in step S603 and the peak time obtained in step S607 as a peak time difference. In step S609, the control unit 10 calculates a ratio of the peak value obtained in step S603 and the peak value obtained in step S607 as a transmission coefficient.

In step S610, the control unit 10 determines the number of times of data acquisition of the recording material P. When the number of times of data acquisition is 1 (NO in step S610), the processing returns to step S607, and the control unit 10 acquires data again. Since it is necessary to calculate the ratio of the peak time difference and the difference between the transmission coefficients to determine the double feed, the control unit 10 performs the data acquisition twice or more.

When the number of times of data acquisition is 2 or more (YES in step S610), in step S611, the control unit 10 calculates a ratio of a peak time difference first acquired and a peak time difference acquired second or thereafter. In step S612, the control unit 10 compares the value calculated instep S611 with a previously set value. As a result of the comparison, when the calculated value is smaller than the set value (NO in step S610), the control unit 10 determines that the recording materials P are not doubly fed, and the processing proceeds to step S613. When the calculated value is more than the set value (YES in step S610), the control unit 10 determines that the recording materials P are doubly fed, and ends the processing.

In step S613, the control unit 10 calculates a difference between a transmission coefficient first acquired and a transmission coefficient acquired second or thereafter. Instep S614, the control unit 10 compares the value calculated in step S613 with a previously set value. As a result of the comparison, when the calculated value is smaller than the set value (NO in step 613), the control unit 10 determines that the recording materials P are not doubly fed, and the processing proceeds to step S615. When the calculated value is more than the set value (YES in step 613), the control unit 10 determines that the recording materials P are doubly fed, and ends the processing.

In step S615, the control unit 10 determines whether the number of times of data acquisition reaches the number of times of end of data acquisition. When the number of times of data acquisition does not reach the number of times of end of data acquisition (NO in step S615), the processing returns to step S607, and the control unit 10 acquires data again. When the number of times of data acquisition reaches the number of times of end of data acquisition (YES in step S615), the control unit 10 determines that the recording materials P are not doubly feed, and the processing proceeds to step S616.

In step S616, the control unit 10 detects a basis weight of the recording material based on the transmission coefficient calculated more than once in step S609. The control unit 10 determines the detection of the basis weight using an average value obtained by averaging the transmission coefficients for the measured number of times.

Since the transmission coefficient is different according to the ambient environment, the control unit 10 corrects the calculated transmission coefficient. A ratio of pulse amplitude obtained by previously adjusting under a known environment and pulse amplitude adjusted under the present environment in step S605 is defined as a correction coefficient.

This is an example in the present exemplary embodiment, and may be a coefficient involving the detection of the ambient environmental variation. The control unit 10 determines the basis weight of the conveyed recording material from the relation between the basis weight and the transmission coefficient of the recording material illustrated in FIG. 14 using the average value of the corrected transmission coefficients.

The value of the transmission coefficient illustrated in FIG. 14 is a value obtained by considering not only a ratio of the peak value in a state where the recording material is not present between the ultrasonic wave emitting unit and the ultrasonic wave receiving unit and the peak value of the recording material but also a difference between amplification factors of the detection circuit 342 for detecting the received signal of the recording material. Since the amplification factor is a uniformly fixed value, the relation between the basis weight and the transmission coefficient of the recording material is not changed without considering the amplification factor.

A method for extracting a time and a value of the extracted peak once in one measurement is described. As illustrated in FIGS. 3A, 3B, and 3C, a plurality of peaks can also be detected in one measurement. The time and the value of each of the plurality of peaks are extracted, and thereby the double feed can be determined and the basis weight of the recording material can be detected based on a plurality of calculation results. Furthermore, the transmission coefficient is corrected in step S615, however, the transmission coefficient can also be corrected when the transmission coefficient is calculated in step S609.

Thus, the double feed of the recording materials P can be precisely determined by combining two parameters, i.e., the difference between the peak times and the change amount of the peak value. After the control unit 10 determines that the recording materials P are not doubly fed, the control unit 10 can also detect the basis weight of the recording material P using the transmission coefficient used for the determination of the double feed. Thereby, a common unit and control unit can be used without determining the double feed of the recording materials P and detecting the basis weight using another unit or another control unit, thereby lowering costs.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-177141 filed Aug. 12, 2011, which is hereby incorporated by reference herein in its entirety.

What is claimed is:

1. A recording material determination device comprising:
an emitting unit configured to emit an ultrasonic wave;
a transmission unit configured to transmit a drive signal for emitting the ultrasonic wave from the emitting unit;
a receiving unit configured to receive the ultrasonic wave emitted from the emitting unit and having passed through a recording material; and
a control unit configured to measure a time until a peak of a received signal of the ultrasonic wave received by the receiving unit is detected after the drive signal is transmitted by the transmission unit,
wherein the control unit causes the emitting unit to emit the ultrasonic wave more than once, measures the time more than once, and determines whether the recording materials are doubly fed based on a difference between the times measured more than once.

2. The recording material determination device according to claim 1, wherein the control unit determines that the recording materials are doubly fed when the difference between the times exceeds a first threshold value.

3. The recording material determination device according to claim 1, wherein the control unit causes the emitting unit to emit the ultrasonic wave more than once, measures a peak value of a received signal of the ultrasonic wave received by the receiving unit, more than once, and determines a double feed state of the recording materials based on a difference between the peak values measured more than once.

4. The recording material determination device according to claim 3, wherein the control unit determines that the recording materials are doubly fed when the difference between the peak values exceeds a second threshold value.

5. The recording material determination device according to claim 1, wherein when the control unit determines that the recording materials are not doubly fed, the control unit determines a basis weight of the recording material based on a ratio of a peak value of the received signal of the ultrasonic wave detected in a state where the recording material is not present between the emitting unit and the receiving unit and a peak value of the received signal of the ultrasonic wave detected in a state where the recording material is present between the emitting unit and the receiving unit.

6. The recording material determination device according to claim 5, wherein the control unit corrects the ratio of the peak value of the received signal of the ultrasonic wave detected in a state where the recording material is not present between the emitting unit and the receiving unit and the peak value of the received signal of the ultrasonic wave detected in a state where the recording material is present between the emitting unit and the receiving unit, based on the ratio of the peak value of the received signal of the ultrasonic wave detected in a state where the recording material is not present between the emitting unit and the receiving unit in a present environment and the peak value of the received signal of the ultrasonic wave detected in a state where the recording material is not present between the emitting unit and the receiving unit in a known environment.

7. The recording material determination device according to claim 5, further comprising an adjusting unit configured to adjust a pulse amplitude of the drive signal,
wherein the control unit corrects the ratio of the peak value of the received signal of the ultrasonic wave detected in a state where the recording material is not present between the emitting unit and the receiving unit and the peak value of the received signal of the ultrasonic wave detected in a state where the recording material is present between the emitting unit and the receiving unit, based on a ratio of a value of the pulse amplitude of the ultrasonic wave adjusted by the adjusting unit in a state where the recording material is not present between the emitting unit and the receiving unit in a present environment and a value of pulse amplitude of the ultrasonic wave adjusted by the adjusting unit in a state where the recording material is not present between the emitting unit and the receiving unit in a known environment.

8. A recording material determination device comprising:
an emitting unit configured to emit an ultrasonic wave;
a transmission unit configured to transmit a drive signal for emitting the ultrasonic wave from the emitting unit;
a receiving unit configured to receive the ultrasonic wave emitted from the emitting unit and having passed through a recording material; and
a control unit configured to measure a peak value of a received signal of the ultrasonic wave received by the receiving unit,
wherein the control unit causes the emitting unit to emit the ultrasonic wave more than once, measures the peak value more than once, and determines a double feed state of the recording materials based on a difference between the peak values measured more than once.

9. The recording material determination device according to claim 8, wherein the control unit determines that the recording materials are doubly fed when the difference between the peak values exceeds a second threshold value.

10. A recording material determination device comprising:
an emitting unit configured to emit an ultrasonic wave;
a transmission unit configured to transmit a drive signal for emitting the ultrasonic wave from the emitting unit;
a receiving unit configured to receive the ultrasonic wave emitted from the emitting unit and having passed through a recording material; and
a control unit configured to measure a time until a peak of a received signal of the ultrasonic wave received by the receiving unit is detected after the drive signal is transmitted by the transmission unit,
wherein the control unit measures a first time when the ultrasonic wave is emitted and measured in a state where the recording material is not present between the emitting unit and the receiving unit, a second time when the ultrasonic wave is first emitted and measured in a state where the recording material is present between the emitting unit and the receiving unit, and a third time when the ultrasonic wave is emitted and measured second or thereafter in a state where the recording material is present between the emitting unit and the receiving unit; and
the control unit obtains a first difference between the first time and the second time, and a second difference between the first time and the third time, and determines double feed of the recording materials based on a ratio of the first difference and the second difference.

11. The recording material determination device according to claim 10, wherein the control unit determines that the recording materials are doubly fed when the ratio of the first difference and the second difference exceeds a threshold value.

12. A recording material determination device comprising:
an emitting unit configured to emit an ultrasonic wave;
a transmission unit configured to transmit a drive signal for emitting the ultrasonic wave from the emitting unit;
a receiving unit configured to receive the ultrasonic wave emitted from the emitting unit and having passed through a recording material; and
a control unit configured to measure a peak value of a received signal of the ultrasonic wave received by the receiving unit,
wherein the control unit measures a first value obtained by emitting and measuring the ultrasonic wave in a state where the recording material is not present between the emitting unit and the receiving unit, a second value obtained by firstly emitting and measuring the ultrasonic wave in a state where the recording material is present between the emitting unit and the receiving unit, and a third value obtained by secondly emitting and measuring the ultrasonic wave in a state where the recording material is present between the emitting unit and the receiving unit, and
the control unit obtains a first ratio of the first value and the second value, and a second ratio of the first value and the second value, and determines double feed of the recording materials based on a difference between the first ratio and the second ratio.

13. The recording material determination device according to claim 12, wherein the control unit determines that the recording materials are doubly fed when the difference between the first ratio and the second ratio exceeds a threshold value.

14. A recording material determination device comprising:
an emitting unit configured to emit an ultrasonic wave;
a transmission unit configured to transmit a drive signal for emitting the ultrasonic wave from the emitting unit;
a receiving unit configured to receive the ultrasonic wave emitted from the emitting unit and having passed through a recording material; and
a control unit configured to measure a time until a peak of a received signal of the ultrasonic wave received by the receiving unit is detected after the drive signal is transmitted by the transmission unit, and configured to measure a peak value of a received signal of the ultrasonic wave received by the receiving unit,
wherein the control unit measures a first time when the ultrasonic wave is emitted and measured in a state where the recording material is not present between the emitting unit and the receiving unit, a second time when the ultrasonic wave is first emitted and measured in a state where the recording material is present between the emitting unit and the receiving unit, a third time when the ultrasonic wave is emitted and measured second or thereafter in a state where the recording material is present between the emitting unit and the receiving unit,
a first value obtained by emitting and measuring the ultrasonic wave in a state where the recording material is not present between the emitting unit and the receiving unit,
a second value obtained by first emitting and measuring the ultrasonic wave in a state where the recording material is present between the emitting unit and the receiving unit, and
a third value obtained by secondly emitting and measuring the ultrasonic wave in a state where the recording material is present between the emitting unit and the receiving unit; and
the control unit obtains a first difference between the first time and the second time, and a second difference between the first time and the third time, obtains a first ratio of the first value and the second value, and a second ratio of the first value and the second value, determines double feed of the recording materials based on a ratio of the first difference and the second difference, and a difference between the first ratio and the second ratio, and determines a basis weight of the recording material using the second value or the third value when the control unit determines that the recording materials are not doubly fed.

15. The recording material determination device according to claim 14, wherein the control unit corrects a ratio of the peak value of the received signal of the ultrasonic wave detected in a state where the recording material is not present between the emitting unit and the receiving unit and the peak value of the received signal of the ultrasonic wave detected in a state where the recording material is present between the emitting unit and the receiving unit, based on the ratio of the peak value of the received signal of the ultrasonic wave detected in a state where the recording material is not present between the emitting unit and the receiving unit in a present environment and the peak value of the received signal of the ultrasonic wave detected in a state where the recording material is not present between the emitting unit and the receiving unit in a known environment.

16. The recording material determination device according to claim 14, further comprising an adjusting unit configured to adjust pulse amplitude of the drive signal,
wherein the control unit corrects a ratio of the peak value of the received signal of the ultrasonic wave detected in a state where the recording material is not present between the emitting unit and the receiving unit and a peak value of the received signal of the ultrasonic wave detected in a state where the recording material is present between the emitting unit and the receiving unit, based on a ratio of a value of pulse amplitude of the ultrasonic wave adjusted by the adjusting unit in a state where the recording material is not present between the emitting unit and the receiving unit in a present environment and a value of pulse amplitude of the ultrasonic wave adjusted by the adjusting unit in a state where the recording material is not present between the emitting unit and the receiving unit in a known environment.
